(19) United States
(12) Patent Application Publication
(10) Pub. No.: US 2021/0272140 A1
(43) Pub. Date: Sep. 2, 2021

(54) SYSTEMS AND METHODS FOR AN ONLINE MUSIC MARKETPLACE

(71) Applicant: PEERTRACKS INC., Houston, TX (US)

(72) Inventors: Cédric Cobban, Sherbrooke (CA); Edward Corral, Houston, TX (US)

(21) Appl. No.: 17/325,159

(22) Filed: May 19, 2021

Related U.S. Application Data
(63) Continuation of application No. 15/174,943, filed on Jun. 6, 2016, now abandoned.
(60) Provisional application No. 62/171,485, filed on Jun. 5, 2015.

(51) Int. Cl. G06Q 30/02; G06Q 20/06; G06Q 20/36

(52) U.S. Cl. CPC G06Q 30/0201; G06Q 20/36; G06Q 20/0655

(57) ABSTRACT

Systems and methods for a comprehensive online music marketplace are provided that increase the efficiency music sharing between artists and consumers. In one embodiment, a method may comprise, in response to a request from an artist, generating a desired number of artist tokens, transmitting the artist tokens to a first digital wallet of the artist device, and performing a digital transaction between a consumer device and the artist device. The digital transaction may include transferring an amount of cryptocurrency from a second digital wallet of the consumer device to the first digital wallet of the artist device, in exchange for one or more of artist tokens, artist produced songs, and artist merchandise. Further, in some examples, the method may additionally and/or alternatively comprise destroying a portion of the artist tokens based on one or more of the amount of cryptocurrency transferred from the second digital wallet, and a deduction percentage.

### CROSS-REFERENCE TO RELATED APPLICATIONS

The present application is a continuation of U.S. Non-Provisional patent application Ser. No. 15/174,943, entitled “SYSTEMS AND METHODS FOR AN ONLINE MUSIC MARKETPLACE”, and filed on Jun. 6, 2016. U.S. Non-Provisional patent application Ser. No. 15/174,943 claims priority to U.S. Provisional Patent Application No. 62/171,485, entitled “SYSTEMS AND METHODS FOR AN ONLINE MUSIC MARKETPLACE,” filed on Jun. 5, 2015. The entire contents of the above-identified applications are hereby incorporated by reference for all purposes.

### BACKGROUND/SUMMARY

In the modern world, consumers can stream and/or download songs, movies, TV shows, and other forms of digital entertainment. In many cases, consumers pay for the right to stream and/or download this digital entertainment via online entertainment libraries such as Spotify, iTunes, Pandora, Amazon, Hulu, Netflix, HBO, etc. However, the producers of such digital entertainment often receive only a percentage of sales conducted on these third party entertainment libraries, while the third party entertainment libraries hold a significant percentage of the income for themselves.

More specifically, artists, who may be producers, performers, and/or composers of music, often receive only a small portion of the income generated by their music. To further complicate issues, many artists may have difficulty finding their target audiences. In many cases, this is may be partly due to the fact that artists do not become popular enough be discovered by their target audience. As an artist becomes more popular, their music becomes known by a greater number of people, and therefore the chances of their music reaching the ears of consumers who most enjoy their music increases. Put more simply, many consumers who would appreciate and an artist's songs, never do, at least in part because these consumers never discover the artist.

The inventors herein have recognized the issues described above in the digital entertainment marketplace and have devised systems and methods for addressing the issues. In particular, systems and methods for an online music marketplace and user interface are provided. More specifically, the methods and systems described herein provide an approach for connecting consumers directly with artists and their songs. Further, artists may be paid directly by consumers in exchange for downloading and/or streaming artists' songs.

The present invention provides, among other advantages, methods and systems for discovering artists, downloading and/or streaming their songs, promoting said artists, and paying them directly in the form of cryptocurrency. In one embodiment, a method comprises responsive to an artist request via an artist device, generating a desired number of artist tokens, transmitting the artist tokens to a first digital wallet of the artist device via a network, performing a digital transaction between a consumer device and the artist device, where the digital transaction includes transferring an amount of cryptocurrency from a second digital wallet of the consumer device to the first digital wallet of the artist device, in exchange for one or more of artist tokens, artist produced songs, and artist merchandise. Additionally, the method may include destroying a portion of the artist tokens based on one or more of the amount of cryptocurrency transferred from the second digital wallet, and a deduction percentage.

In another representation, a method may comprise receiving a subscription fee from a consumer device, transmitting one or more songs from a music database to a user device based on song requests received from the user device during a subscription period, splitting the subscription fee amongst one or more artist wallets of one or more artists based on a proportion of the one or more songs transmitted to the user device that belong to each of the one or more artists, destroying artist tokens for each of the one or more artists based on the splitting of the subscription fee, adjusting values of artist tokens for each of the one or more artists based on a number of destroyed artist tokens for each of the one or more artists, monitoring values of the artist tokens over a duration, and displaying a graph to the user device depicting changes in the values of the artist tokens over the duration.

In yet a further representation, a system may comprise a consumer device for streaming and downloading music, an artist device for uploading music, and a remote server in wireless communication with the consumer device and artist device for receiving and storing music uploaded from the artist device and delivering the music to the consumer device, the remote server comprising computer readable instruction stored in non-transitory memory for: transferring artist tokens from the artist device to the consumer device in exchange for cryptocurrency from the consumer device, and transferring cryptocurrency from the consumer device to the artist device based on a number of songs streamed and/or downloaded by the consumer device and belonging to an artist of the artist device.

In this way, an online music marketplace is provided that allows consumers to search for artists, download and/or stream their songs, pay the artists directly for downloading and/or streaming their songs, and promote the artists by purchasing their artist tokens. The artist tokens may be bought, sold, and traded in an open online marketplace, and as such the value of a particular artist's tokens, may be subject to the supply and demand constraints of the marketplace. As an aspiring artist gains popularity from increases in the amount of consumer streaming and/or downloading of their music, the value of their tokens may increase. Increases in the value of their token may incentivize more consumers to purchase their artist tokens, which may further increase their value. Thus, a positive feedback loop is created in which, increases in the number of songs of an artist listened to by consumers, increases the value of that artist's tokens. Increases in the value of the artist token increases attention drawn to that artist, and the demand for the tokens. As such, artists may increase the amount of revenue they generate, by receiving funds directly from their listeners. Further, artists may more easily become popular through the use of the artist tokens.

The above summary is provided to introduce a selection of concepts in a simplified form that are further described below in the Detailed Description. This summary is not intended to identify key features or essential features of the subject matter, nor is it intended to be used to limit the scope of the subject matter. Furthermore, the subject matter is not limited to implementations that solve any or all of the disadvantages noted above or in any part of this disclosure.

### BRIEF DESCRIPTION OF THE FIGURES

FIG. 1 shows a high-level illustration of an example online music marketplace, in accordance with an embodiment of the present disclosure.

FIG. 2 illustrates an overview of another embodiment of the online music marketplace shown in FIG. 1, in accordance with an embodiment of the present disclosure.

FIG. 3 illustrates another example of the online music marketplace shown in FIG. 1, in accordance with an embodiment of the present disclosure.

FIG. 4A shows a flow chart of an example method for performing transactions involving artist token, in accordance with an embodiment of the present disclosure.

FIG. 4B shows a flow chart of an example method for splitting a user subscription fee amongst one or more artists, in accordance with an embodiment of the present disclosure.

FIG. 4C shows a flow chart of an example method for delivering user requested songs to a user device and for transferring payment directly from the user device to an artist device, in accordance with an embodiment of the present disclosure.

FIG. 5 shows a flow chart of an example method for providing and supporting an online music marketplace, such as the online music marketplace shown in FIG. 1, in accordance with an embodiment of the present disclosure.

FIG. 6 shows a flow chart of an example method for transferring payments directly from a consumer to an artist, in accordance with an embodiment of the present disclosure.

FIG. 7A illustrates a first example online music marketplace interface for an artist, in accordance with an embodiment of the present disclosure.

FIG. 7B illustrates a second example online music marketplace interface for a user, in accordance with an embodiment of the present disclosure.

FIG. 7C illustrates a third example online music marketplace interface for a user, in accordance with an embodiment of the present disclosure.

FIG. 7D illustrates a fourth example online music marketplace interface for a user, in accordance with an embodiment of the present disclosure.

FIG. 7E illustrates a fifth example online music marketplace interface for a user, in accordance with an embodiment of the present disclosure.

FIG. 7F illustrates a sixth example online music marketplace interface for a user, in accordance with an embodiment of the present disclosure.

FIG. 7G illustrates a seventh example online music marketplace interface for a user, in accordance with an embodiment of the present disclosure.

FIG. 7H illustrates an eighth example online music marketplace interface for a user, in accordance with an embodiment of the present disclosure.

### DETAILED DESCRIPTION

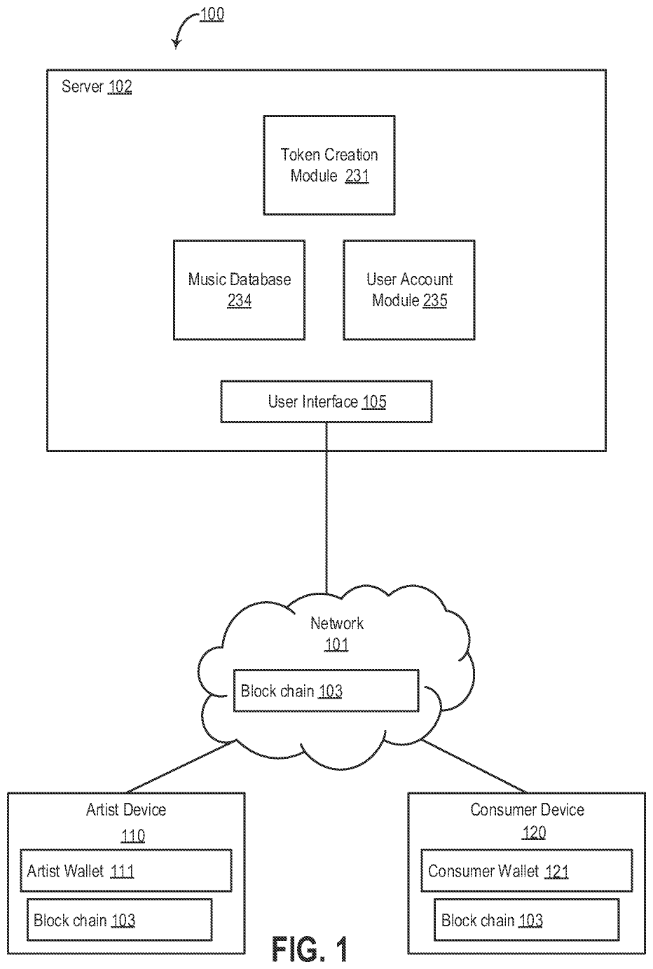

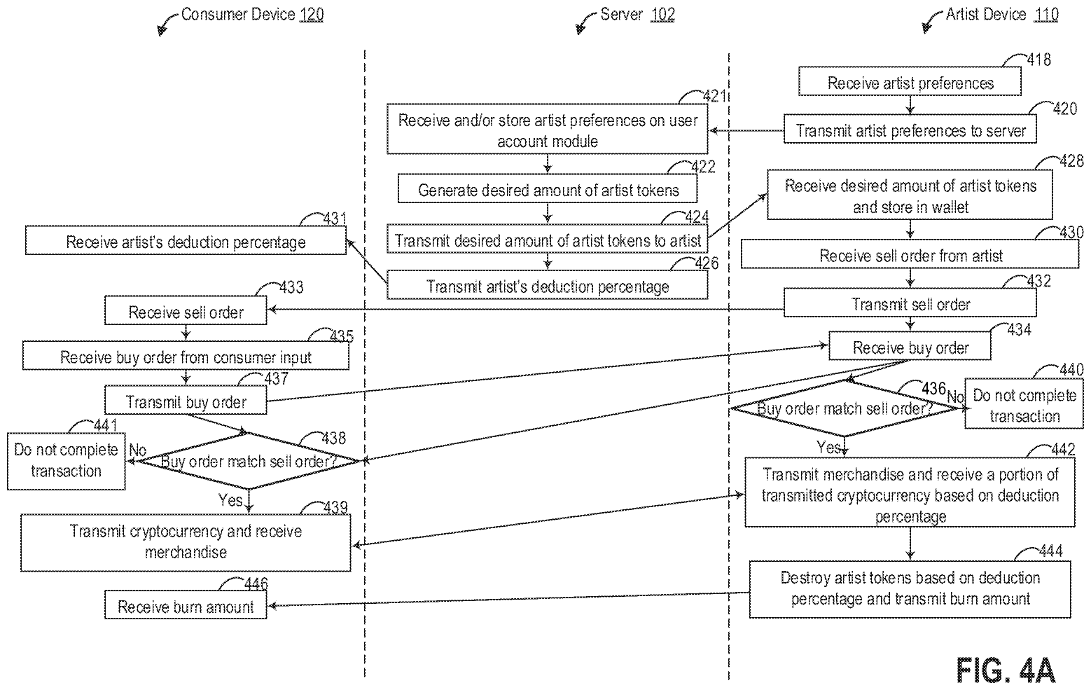

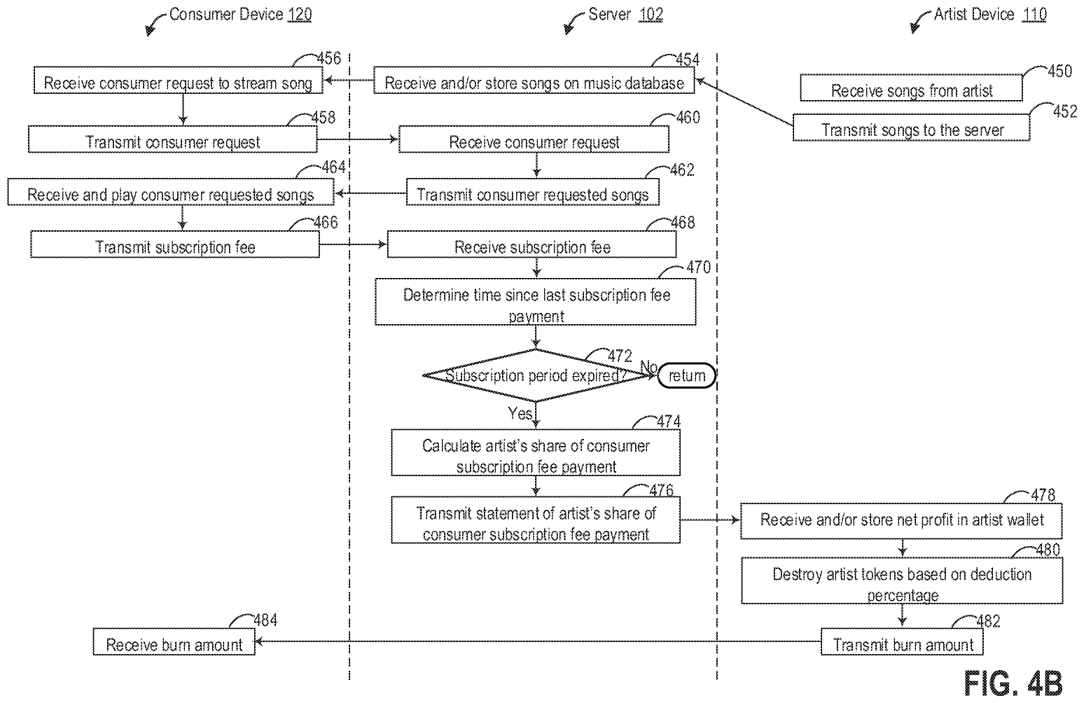

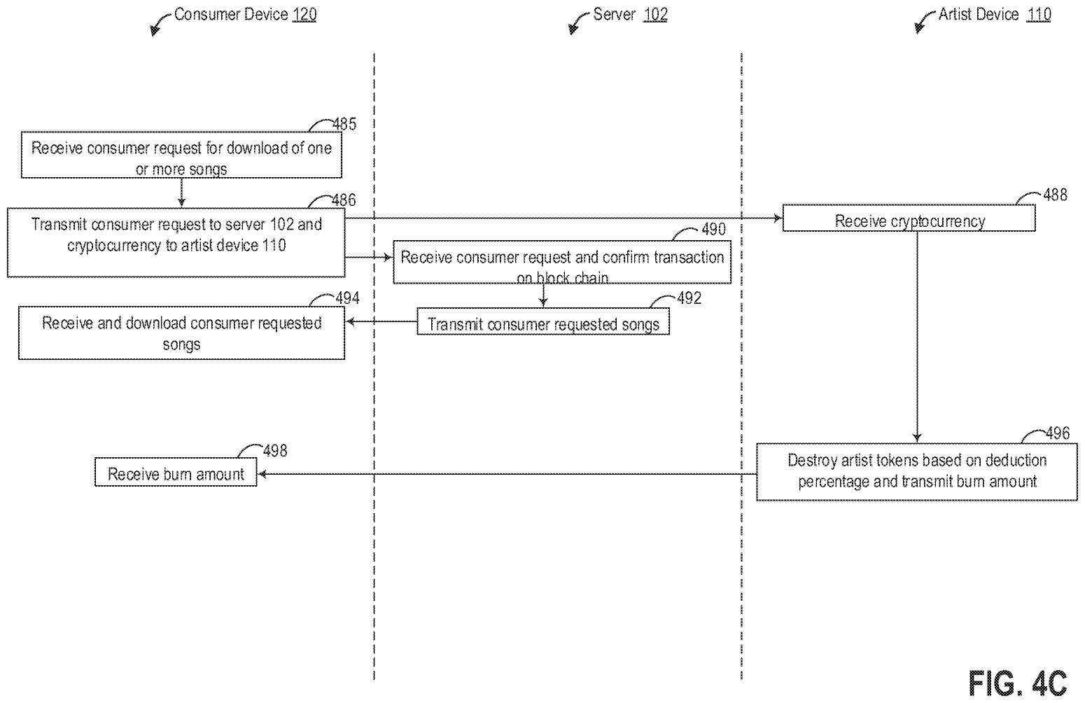

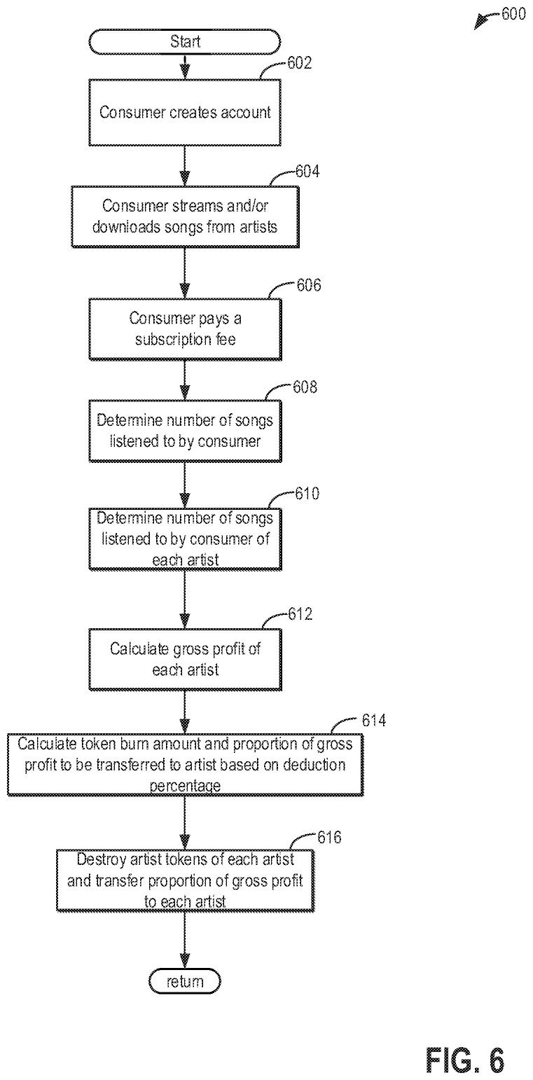

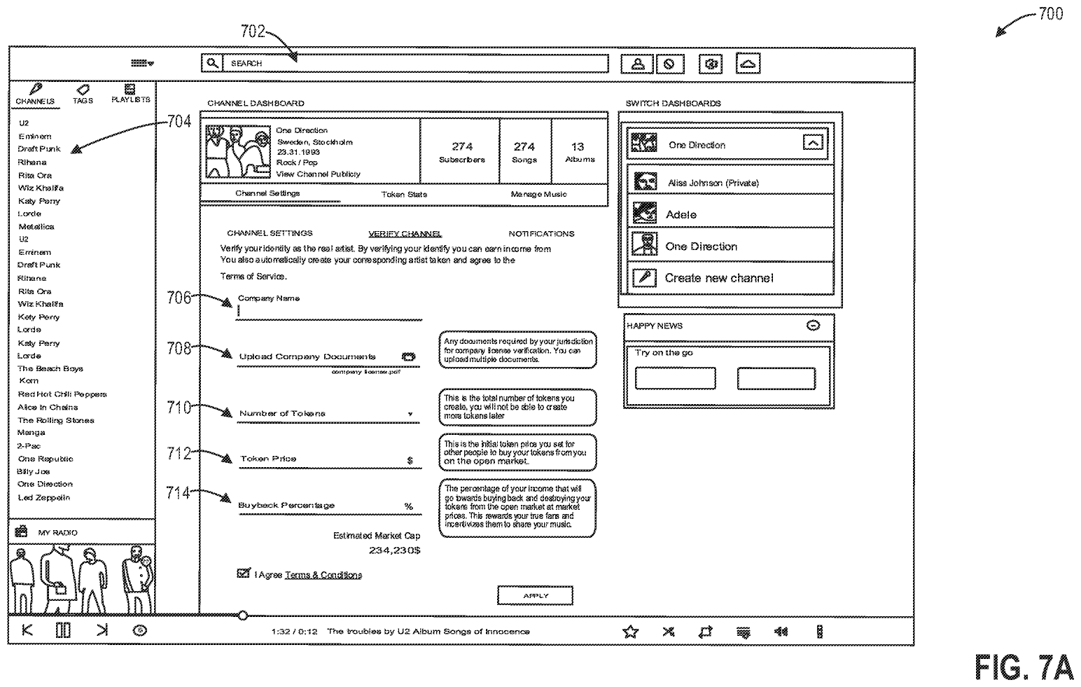

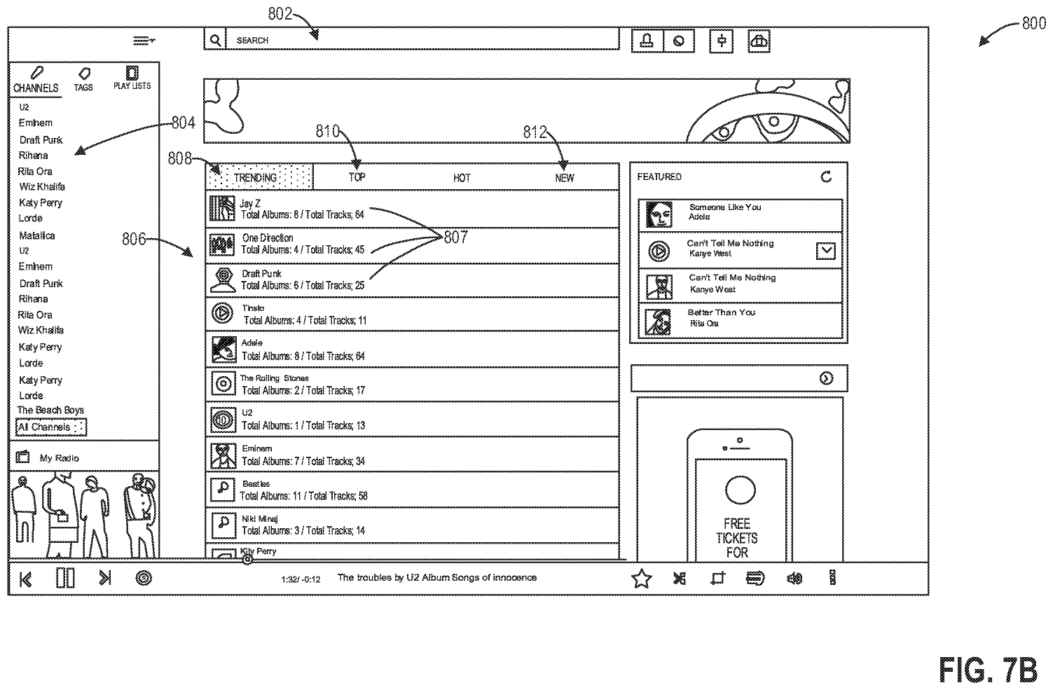

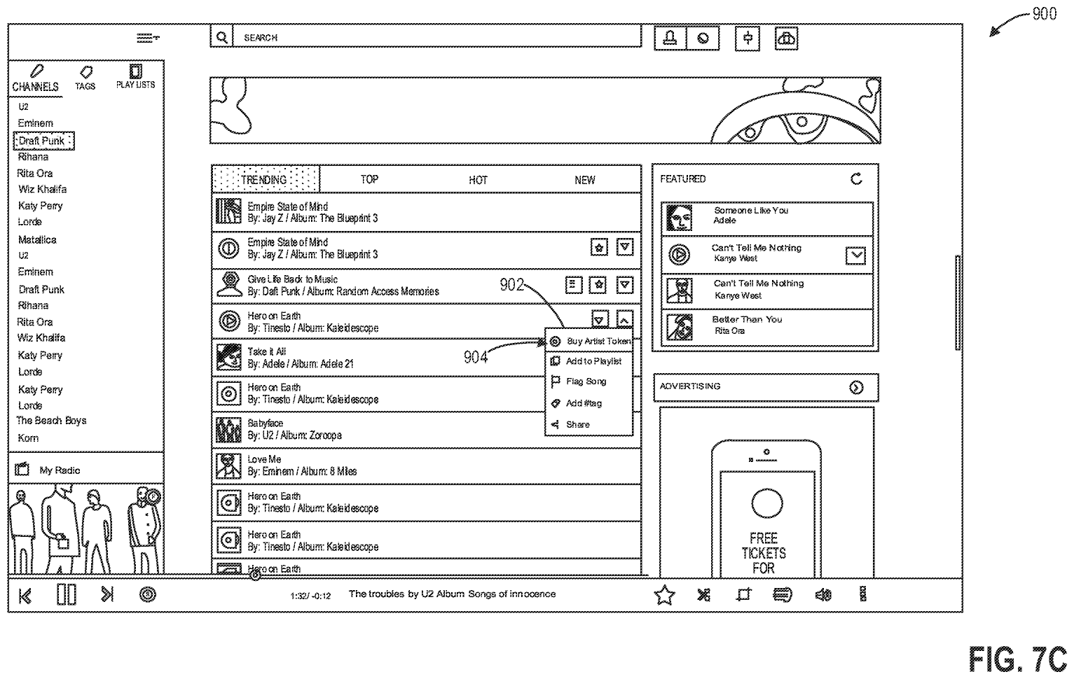

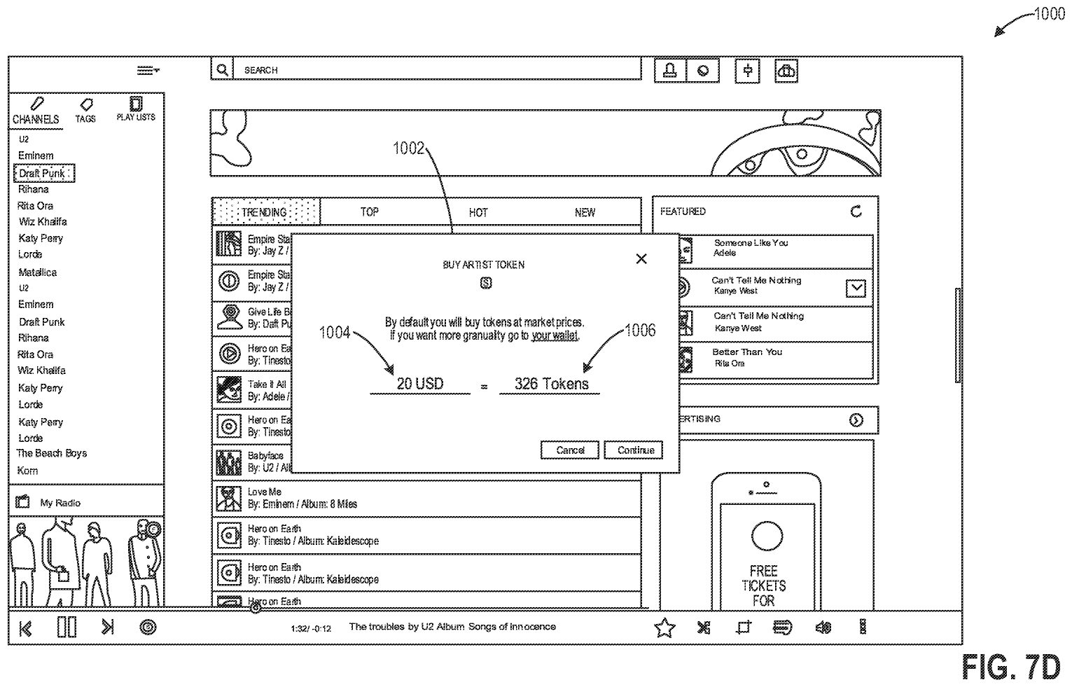

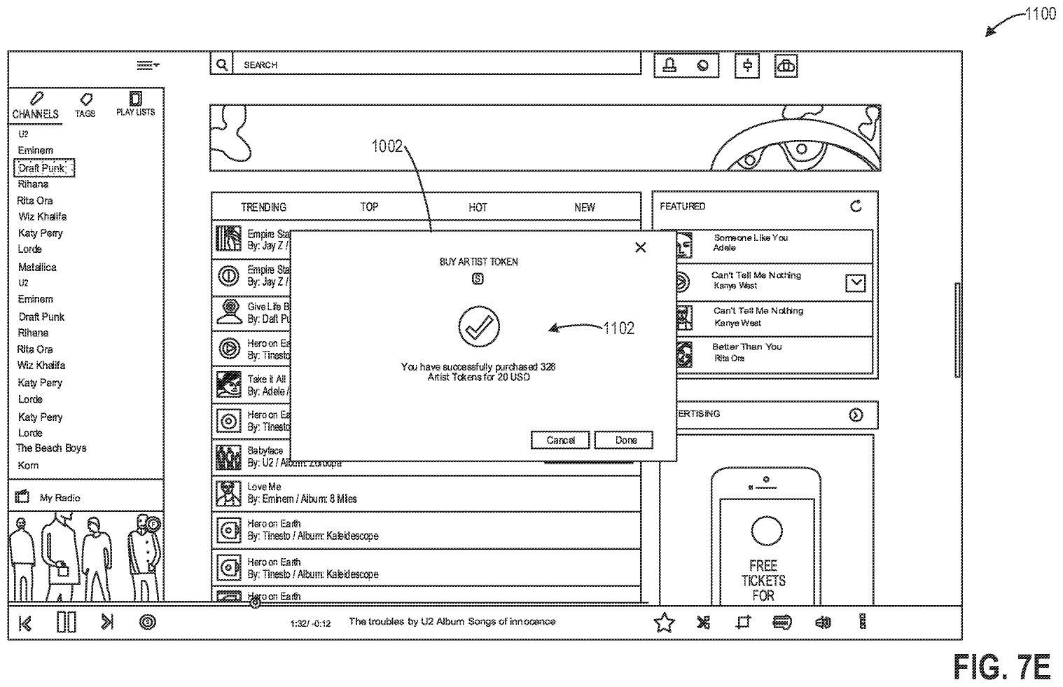

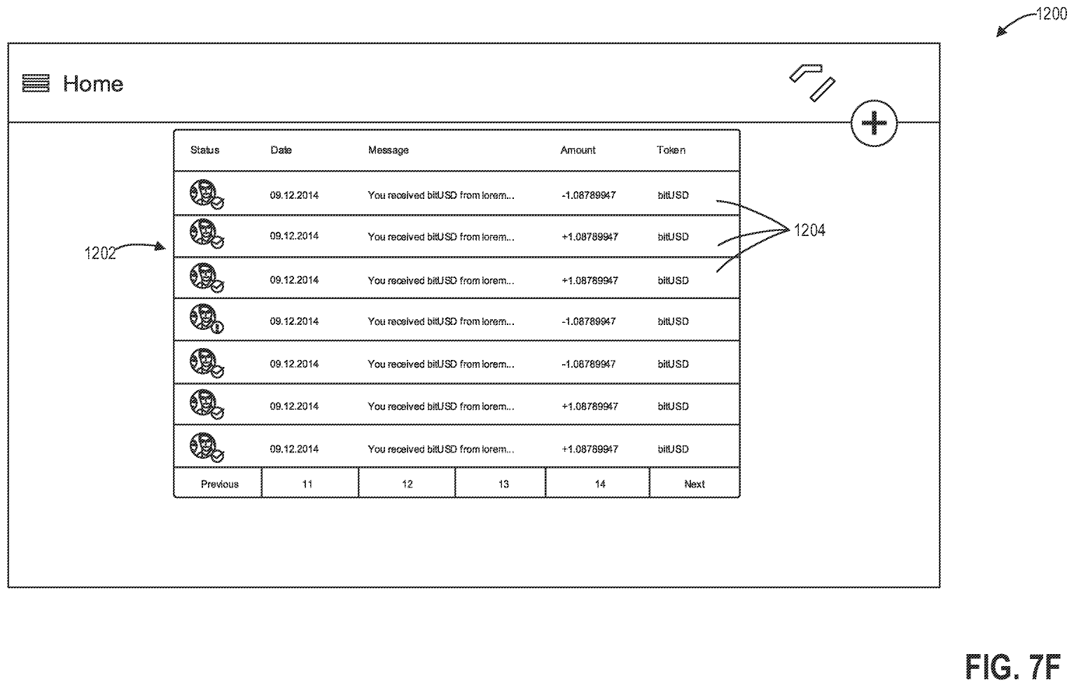

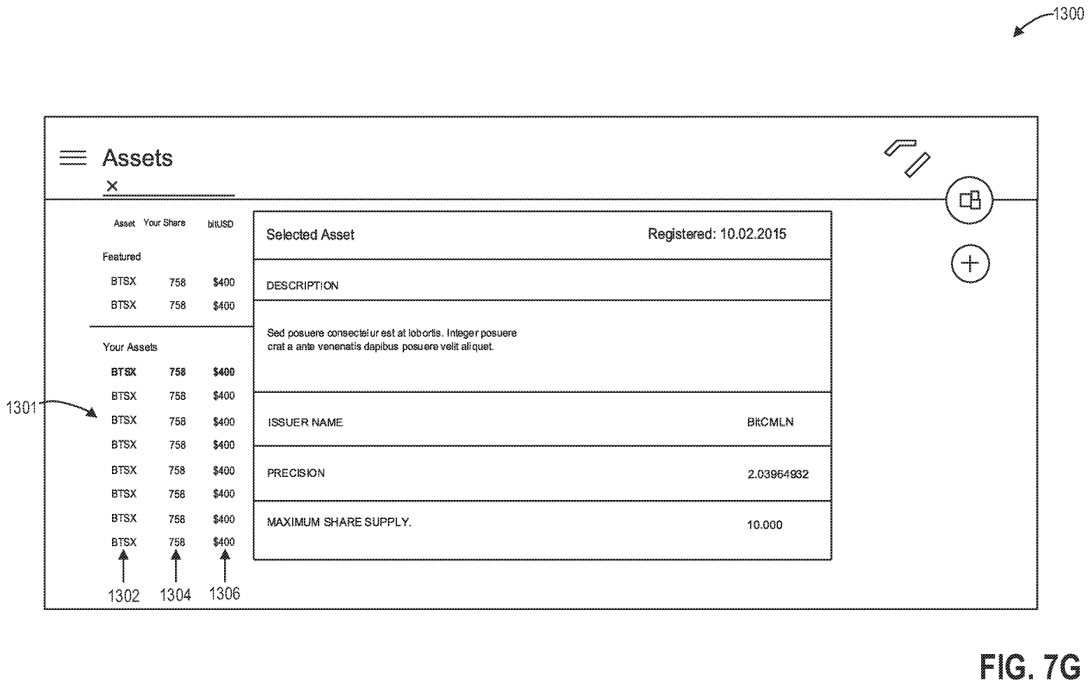

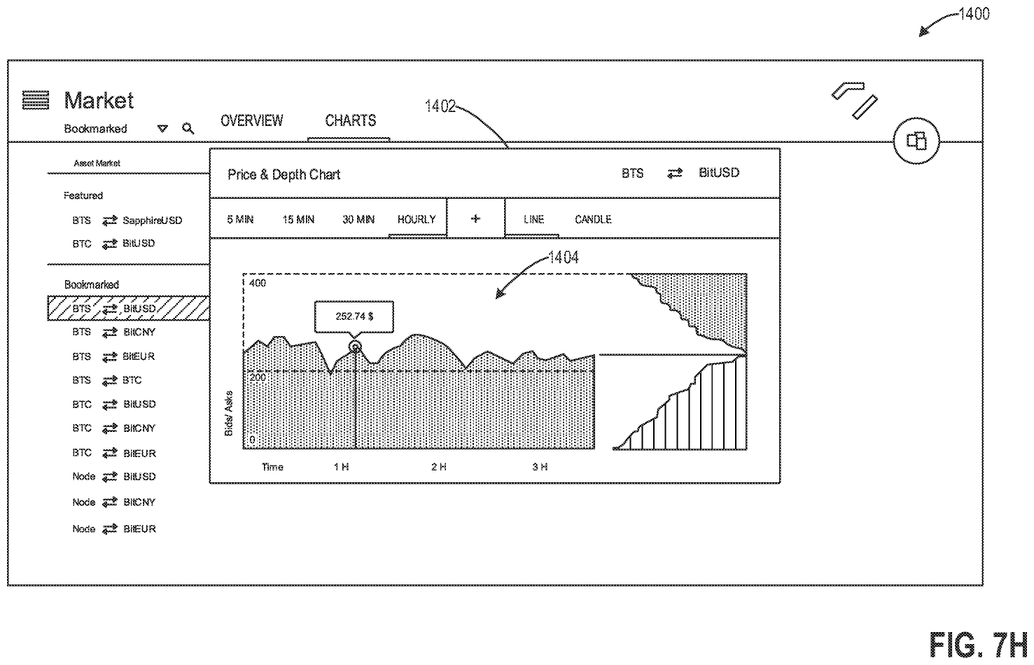

Methods and systems are provided herein for an online music marketplace. The online music marketplace may allow consumers and artists to share music, and payments for that music directly with one another on a peer to peer network. A plurality of consumers and artists may be connected with one another on a network, such as the example networks shown in FIGS. 1-3. Consumer and artists may interact with the online music marketplace through user interfaces (examples of which are shown in FIGS. 7A-7H) which may be displayed on user devices. Artists may upload their music to a server, which consumers may then download and/or stream on their consumer devices. Consumers may pay a subscription fee at regular time intervals (e.g. monthly) to stream songs from one or more of the artists in the network. The consumer's subscription fee may then be divided and split between the artists whose songs the consumer listened to. Thus, the proportion of the consumer's subscription fee that is given to a particular artist is dependent on how much of that artist's music the consumer listened to relative to other artists, as described in FIG. 4B, and FIG. 6.

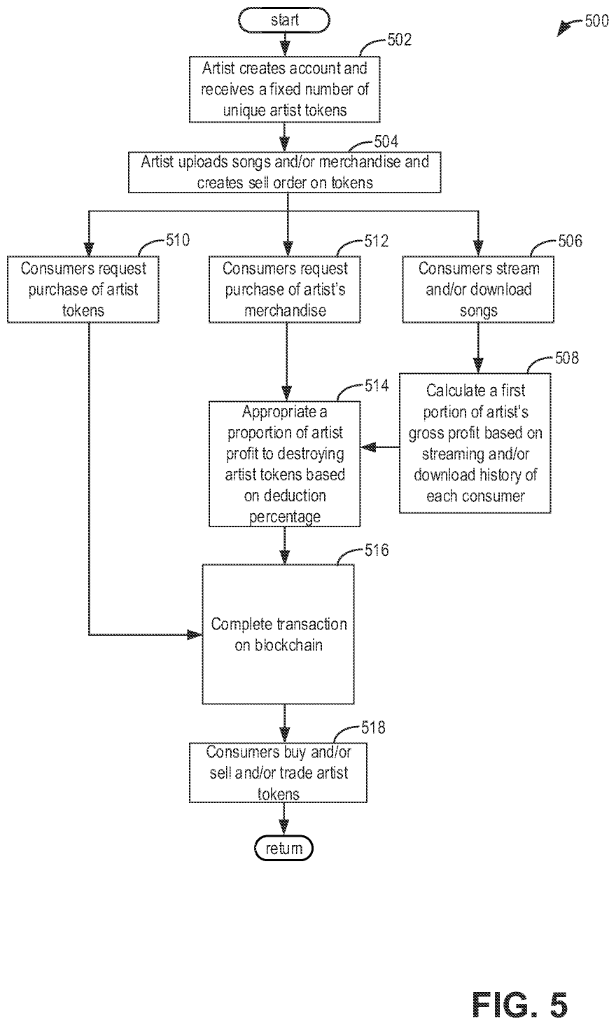

Additionally, each artist may be assigned a fixed number or artist tokens, which may be in the form of a cryptocurrency. These tokens may be traded, sold, and bought amongst the consumers and artists in the network. Transactions involving cryptocurrency in the online music marketplace may be stored in a block chain, which itself may be stored and maintained on all of the devices connected to the network. Thus, as shown in FIGS. 4A, and 5, transactions between artists and consumers, and between consumers, may be recorded in the block chain. The value of the artist tokens may fluctuate depending on demand for the artist tokens. However, whenever an artist earns an income, whether it is from the download and/or streaming of their songs, and/or through the sale of physical and/or digital merchandise, a portion of that income may be used to buy artist tokens and then destroy them. Thus, the total number of artist tokens may decrease with increases in the income generated by an artist. As such, the value of their artist token may increase.

In this way, the popularity of an artist may be indicated by the value of their artist token. Further, as the value of an artist's token increases, the perceived popularity of that artist increases, and therefore consumers may purchase more of the artist token, in the hope that the value of the artist token will continue to increase. As such, the use of artist tokens in the online music marketplace creates an online market which may be subject to, and may fluctuate with, the forces of supply and demand. In this way, an artist token may be representative of an artist's popularity. As a result, an artist may become more popular, and therefore may generate more income, for increases in the value of their artist token.

FIG. 1 shows a high-level block diagram of an embodiment an online music marketplace 100. The online music marketplace 100 may allow artists to sell their music directly to consumers on a peer to peer network. Thus, a plurality of artists and consumers may participate in the online music marketplace 100. The online music marketplace 100 may include one or more servers, and a plurality of user devices through which the artists and consumers may interact with the online music marketplace 100. In the example of the online music marketplace 100 shown in FIG. 1, only one artist device 100 and one consumer device 120 is shown for simplicity. However, it is important to note that the online music marketplace 100 comprises a plurality of artist devices 110 and consumer devices 120.

In the description herein, an artist may be defined as an individual, or a group of individuals that compose and/or perform one or more musical songs. Additionally or alternatively, an artist may comprise an individual or a group of individuals with a copyright license to one or more songs, such that that the individual or group of individuals have exclusive rights to one or more of the production, publication, and distribution of the one or more songs. An artist may upload songs to a server 102 via a network 101. Thus, an artist may download songs to their artist device 110, and those songs may then be stored on a music database 234 on the server 102. Artist device 110 may be any computing device configured to access a network such as network 101, including but not limited to a personal computer, a laptop, a smartphone, a tablet, and the like.

In the example shown in FIG. 1, the server 102 comprises a single music database 234, however, in other examples, online music marketplace 100 may comprise more than one server 102, and each server 102 may comprise more than music database 234. The server 102 may comprise a user interface 105. In some examples, the user interface 105 may include one or more physical, non-transitory devices configured to hold data and/or instruction for generating displays to be presented to an artist on their artist device 110. Thus, the user interface 105 may comprise computer readable instructions and/or data for running and/or generating one or more of a mobile app, a software program, and a web page. Said another way, the computer readable instructions that run and generate one or more of a mobile app, software program, and web page may be stored in non-transitory memory on the user interface 105. In some examples, therefore, the user interface 105 may be a mobile app. In other examples, the user interface 105 may be a software program. In still further examples, the user interface 105 may be a web page that may be accessed from the artist device 110 through a web browser such as Firefox, Safari, Google Chrome, etc. As such, the user interface 105 may comprise computer readable instructions for generating displays on the artist device 110. Therefore, an artist may interact with the one or more of a mobile app, web page and/or software program, through the displays generated on their artist device 110. The user interface 105 may enable an artist to upload their songs to the server 102. Example displays that may be presented to an artist via the artist device 110 are shown below with reference to FIGS. 7A and 7F.

A consumer may stream and/or download songs stored on the music database 234 from one or more artists. In the description herein, a consumer may be defined as any individual that interacts via the user interface 105 and streams and/or downloads songs stored on the music database 234. As such, consumers may be individuals that do not upload songs to the music database 234. The consumer may interact with the user interface 105 via a consumer device 120 that may be in wireless and/or wired communication with server 102 via network 101. Consumer device 120 may be any computing device configured to access a network such as network 101, including but not limited to a personal computer, a laptop, a smartphone, a tablet, and the like. The user interface 105 may be a web page that may be accessed from the consumer device 120 through a web browser such as Firefox, Safari, Google Chrome, etc. As such, the user interface 105 may comprise computer readable instructions for generating displays on the consumer device 120. Therefore, a consumer may interact with one or more of a mobile app, web page and/or software program, through the displays generated on their consumer device 120. The user interface 105 may enable a consumer to upload their songs to the server 102. As such, the consumer may search for, view, stream, download, and listen to songs stored on the music database 234 via the user interface 105. Listening to a song may in some examples comprise streaming the song. In other examples, listening to a song may comprise downloading and purchasing the song.

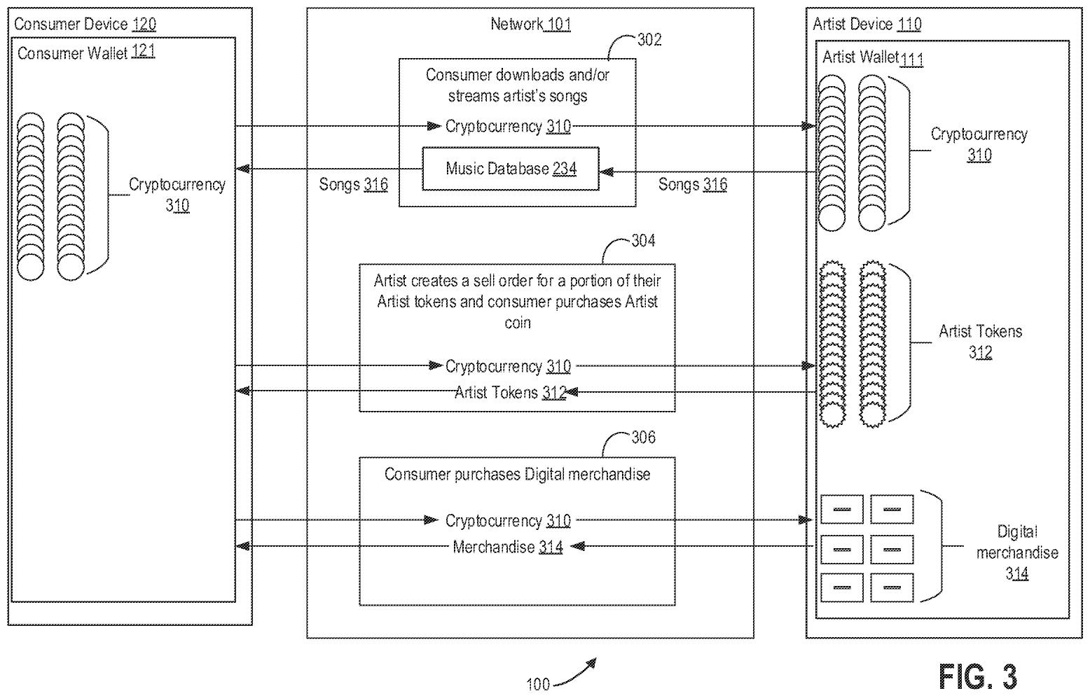

Consumers and artists may engage in direct transactions with one another over network 101. Thus, network 101 may be a peer to peer network that may facilitate transactions between artist devices and consumer devices via a block chain 103. In some examples, network 101 may be the public Internet. In further examples, network 101 may be regarded as a private network connection and may include, for example, a virtual private network or an encryption or other security mechanism employed over the public Internet. As shown in greater detail below with reference to FIGS. 3-4B, a consumer may pay an artist directly for downloading one or more of the artist's songs from the music database 234. In some examples, the consumer may also pay the artist directly for streaming one or more of the artist's songs from the music database 234. Thus, transactions including a transfer and/or exchange of cryptocurrency may occur directly between a consumer device 120 and an artist device 110, without third party involvement. Said another way, cryptocurrency may be transferred between one or more artist devices 110 and one or more consumer devices 120 through network 101. In the description herein, transactions may be used to refer to the transfer, exchange, trade, buying, and/or selling of cryptocurrency. Cryptocurrencies may include one or more of BitUSD, BitCNY, and BitEUR, any derivatives of cryptocurrency, and any other cryptocurrencies or cryptotokens on the network 101. Transactions may be verified by all of the artists devices 110 and consumer devices 120 connected to network 101. Further, all transactions may be recorded on the block chain 103.

Specifically, payments to the artist device 110 from the consumer device 120 may be in the form of cryptocurrency. As such, each artist device 110 may comprise an artist wallet 111, and each consumer device 120 may comprise a consumer wallet 121. The artist wallet 111 and consumer wallet 121 may comprise public and private keys associated with the cryptocurrency belonging to the artist and consumer respectively. Each artist device 110, and each consumer device 120, may comprise one or more public keys which are broadcast through the network 101 to all artist devices and consumer devices in the online music marketplace 100. Cryptocurrencies comprise both a public key and a private key. Thus, the cryptocurrency location is known based on the public key associated with the cryptocurrency, and the owner of that cryptocurrency is the artist device 110 or consumer device 120 which possesses the private key for that cryptocurrency. Thus, a cryptocurrency may only be transferred from the artist device 110 or consumer device 120 containing the private key for that cryptocurrency.

The block chain 103 is a public ledger that comprises a record of all transactions involving cryptocurrency. Transactions on the block chain 103 are independently verified by the artist and consumer devices in the online music marketplace 100. As such, in some examples, each artist device 110, and each consumer device 103, may have a copy of the block chain 103 stored in non-transitory memory. Further, the block chain 103 may expand, as transactions in the online music marketplace 100 continue to occur and be recorded on the block chain 103. After pre-set time intervals, new blocks in the block chain 103 may be published to the block chain, and may be available to each artist device 110 and consumer device 120 via the network 101. In some examples, the time intervals may be microseconds. As such, in some examples the generation of blocks in the block chain 103 may be approximately automatic. In other examples, the time intervals may be seconds. In still further examples, the time intervals may be approximately 1 minute. In other examples the time intervals may be in a range between 1 microsecond and 5 minutes. Thus, after the pre-set time intervals (e.g., 5 microseconds) since the most recent creation of a block, a new block may be created in the block chain 103. Each block in the block chain 103 may comprise information regarding transactions performed in the time since the most recent block in the block chain 103. Thus, all transactions are recorded in a block of the block chain 103, which may be stored on each artist device 110 and consumer device 120 in the online music marketplace 100. Said another way, a transaction is part of a new block in the block chain 103, which records a transfer of ownership of cryptocurrency. Thus, in some examples, a transaction includes a recording in the block chain 103, of a new public key to which cryptocurrency is assigned. Thus, the ownership of cryptocurrency may be known by all artist and consumer devices in wired and/or wireless communication with network 101, since during a transfer of ownership, the new or current public key address of that cryptocurrency is published on the block chain 103.

In other embodiments, only a portion of artist devices and consumer devices may comprise a complete record of the block chain 103. In still further embodiments, the server 102 may comprise a complete record of the block chain 103. The block chain 103 may be stored in computer readable memory on each artist device 110 and consumer device 120.

Both artists and consumers may create user accounts, which may be stored on a user account module 235 on the server 102. An artist account may store artist preferences, and may include a record of the songs uploaded to the music database 234 by the artist. The artist preferences will be described in greater detail below with reference to FIGS. 4A-5. A record of the songs downloaded and/or streamed by the consumer may be saved on the user account module 235. Further, upon creation of an account, an artist may be provided with artist tokens, which are a cryptocurrency. Thus, a token creation module 231 may generate a desired number of artist tokens, which may be a number of tokens desired by the artist. The artist may indicate via displays generated by the user interface 105 on the artist device 110, a desired number of tokens to be created. The token creation module 231 may create the desired number of artist tokens, which may then be assigned to the artist wallet 111. As such, the artist tokens may appear in the artist wallet 111. Said another way, the token creation module 231 may generate one or more private keys for the artist tokens, which may then be transmitted to the artist wallet 111 via network 101. As such, the artist may gain possession of the tokens because the artist wallet 111 may be the only wallet in the online music marketplace 100 with the one or more private keys associated with the artist tokens. In some examples, the artist tokens may be a form of cryptocurrency, and thus may be tied to a physical form of currency such as the US Dollar. However, in other examples, the artist tokens may be a cryptotoken, and may not be tied to physical forms of currency. Thus, artist tokens contain both public and private keys for indicating current ownership of the artist tokens. As such, once artist tokens are created by the token creation module 231, artist tokens may be exchanged, sold, bought, traded, etc., between the artist device 110 and the consumer device 120 on network 101 as described above with reference to the other forms of cryptocurrency already discussed. Further, transactions involving the artist token may be recorded on the block chain 103.

Thus, the user interface 105 may provide a means for artists and consumers to interact with the block chain 103 for conducting transactions. Said another way, artists and consumers may interact directly with displays on their artists device and consumer device respectively, where the displays are generated by computer readable instructions stored on the user interface 105, and where the user interface 105 further provides a medium through which artists and consumers may interact with the block chain 103.

Upon receipt of their artist tokens, artists may then generate sell orders for a portion or all of their artist tokens. The tokens for each artist may be different. Said another way, each artist may have a unique ID associated with their artist tokens. That artist ID may be broadcast to all devices in the music marketplace 100. Therefore, all tokens of a particular artist may have a unique ID associated with them, so that the artist tokens originally assigned to different artist devices 110 may be distinguished from one another.

In further embodiments, consumers may purchase physical and/or tangible goods and/or services in the online music marketplace 100 using cryptocurrency in their consumer wallet 121. In such examples, server 102 may monitor transactions on the block chain 103. If the server 102 identifies a transaction involving the exchange of cryptocurrency from a consumer device 120 to an artist device 110 for physical goods and/or services, the server 102 may then send a request to the artist device 110 to deliver the consumer purchased physical goods to the consumer device 120. Thus, the server 102 may contain an address (e.g., mailing address) for the consumer using the consumer device 120, and may send that address to the artist device 110. In this way, the server 102 may send a notification to the artist device 110, to deliver physical goods purchased by the consumer via the consumer device 120, to the consumer's address. As such, an artist may sell physical goods such as t-shirts, merchandise, CDs, mugs, etc. on the online music marketplace 100, in exchange for payment in the form of cryptocurrency. In such examples, the server 102, may verify and confirm payment of the cryptocurrency, and ensure that the physical goods are delivered to the consumer responsible for paying for those physical goods. However, in other examples, the server 102 may also act as a vendor and provide goods and services to a consumer in exchange for cryptocurrency.

In this way, a system may comprise an online music marketplace, where cryptocurrency may be transferred directly from consumers to artists in exchange for access to songs produced by those artists on a peer to peer network. A more detailed description of the payment process that occurs in exchange for the right to download and/or stream artist songs is described in greater detail below with reference to FIGS. 4A-6. Further, as will be described in greater detail below with reference to FIGS. 3-6, artist tokens may be traded, bought, sold, and exchanged on the peer to peer network. In some examples, a portion of the income (e.g., cryptocurrency) received by an artist may be used to destroy a portion of their artist tokens. Thus, as the number of songs consumers stream and or download from a particular artist increases, the number of artist tokens destroyed may increase, and therefore the remaining artist tokens may decrease, which may result in a corresponding increase in the value of the artist tokens. As such, changes in the value of a particular artist's artist tokens may be indicative of the popularity of the songs of that artist.

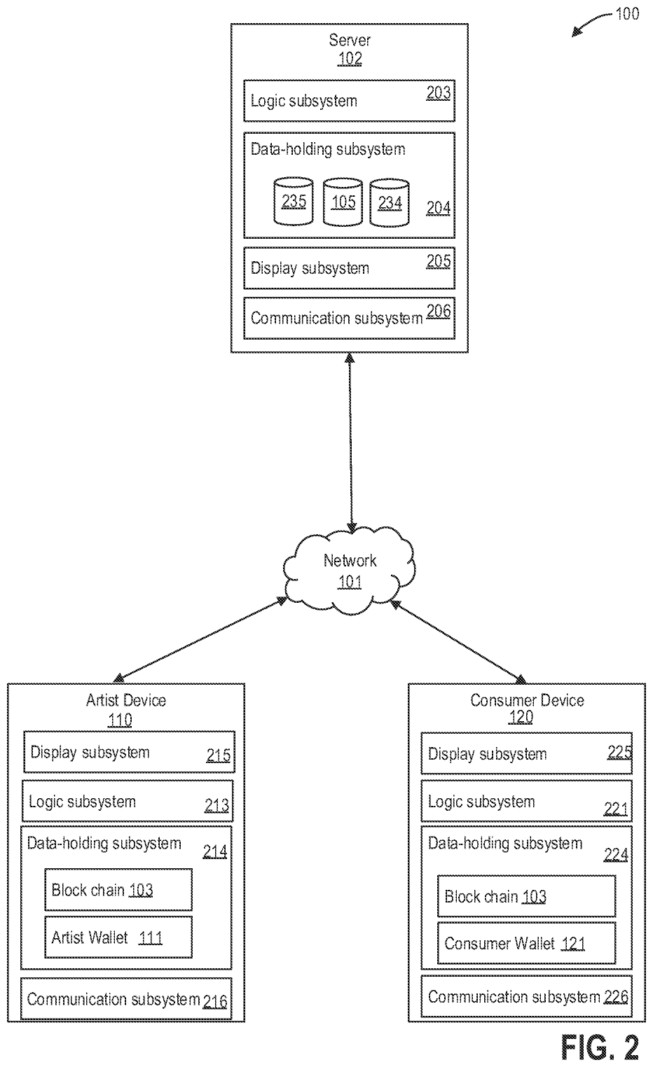

Turning now to FIG. 2, it shows another example embodiment of the online music marketplace 100 shown in FIG. 1. As such, components of the online music marketplace 100 already described in FIG. 1, may not be described again in detail in the description of herein of FIG. 2. Specifically, FIG. 2 shows components of the server 102, artist device 110, and consumer device 120 in more detail.

FIG. 2 is a high level block diagram illustrating the online music marketplace 100 suitable for the streaming and/or downloading of artist songs, purchase of artist token and artist merchandise through a peer to peer network using cryptocurrency. In particular, online music marketplace 100 includes server 102, consumer device 120, artist device 110, and network 101. However, not all of the components illustrated may be required to practice the invention. Variations in the arrangement and type of the components may be made without departing from the spirit or scope of the invention.

Server 102 may be a computing device configured to: generate a user interface through which consumers can stream and/or download songs from artists, where payment for those songs may be transferred in the form of cryptocurrency directly from the consumer to the artist through a network 101, and where a record of such transactions is stored on a block chain 103. In different embodiments, server 102 may take the form of a mainframe computer, server computer, desktop computer, laptop computer, tablet computer, home entertainment computer, network computing device, mobile computing device, mobile communication device, gaming device, etc.

Server 102 may include a logic subsystem 203 and a data-holding subsystem 204. Server 202 may optionally include a display subsystem 205, communication subsystem 206, and/or other components not shown in FIG. 2A. For example, server 202 may also optionally include user input devices such as keyboards, mice, game controllers, cameras, microphones, and/or touch screens.

Logic subsystem 203 may include one or more physical devices configured to execute one or more instructions. For example, logic subsystem 203 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 203 may include one or more processors that are configured to execute software instructions. Additionally or alternatively, the logic subsystem 203 may include one or more hardware or firmware logic machines configured to execute hardware or firmware instructions. Processors of the logic subsystem 203 may be single or multi-core, and the programs executed thereon may be configured for parallel or distributed processing. The logic subsystem 203 may optionally include individual components that are distributed throughout two or more devices, which may be remotely located and/or configured for coordinated processing. For example, the logic subsystem 203 may include several engines for processing and analyzing data. These engines may include a test evaluator engine, user comment engine, user review engine, user feedback engine, etc. These engines may be wirelessly connected to one or more databases for processing data from the databases. One or more aspects of the logic subsystem 203 may be virtualized and executed by remotely accessible networked computing devices configured in a cloud computing configuration.

Data-holding subsystem 204 may include one or more physical, non-transitory devices configured to hold data and/or instructions executable by the logic subsystem 203 to implement the herein described methods and processes. When such methods and processes are implemented, the state of data-holding subsystem 204 may be transformed (for example, to hold different data). For example, the data-holding subsystem may comprise the music database 234, and/or the user interface 105. Thus, the data-holding subsystem 204 may include non-transitory memory with computer readable instructions for generating displays to be displayed on the artist device 110 and consumer device 120. Further, the data-holding subsystem 204 may include non-transitory data relating to one or songs of artists. As such, the state of the music database 234 may be transformed as new songs are received by the server 102 from the artist device 110.

Data-holding subsystem 204 may include removable media and/or built-in devices. Data-holding subsystem 204 may include optical memory (for example, CD, DVD, HD-DVD, Blu-Ray Disc, etc.), and/or magnetic memory devices (for example, hard drive disk, floppy disk drive, tape drive, MRAM, etc.), and the like. Data-holding subsystem 204 may include devices with one or more of the following characteristics: volatile, nonvolatile, dynamic, static, read/write, read-only, random access, sequential access, location addressable, file addressable, and content addressable. In some embodiments, logic subsystem 203 and data-holding subsystem 204 may be integrated into one or more common devices, such as an application-specific integrated circuit or a system on a chip.

It is to be appreciated that data-holding subsystem 204 includes one or more physical, non-transitory devices. In contrast, in some embodiments aspects of the instructions described herein may be propagated in a transitory fashion by a pure signal (for example, an electromagnetic signal) that is not held by a physical device for at least a finite duration. Furthermore, data and/or other forms of information pertaining to the present disclosure may be propagated by a pure signal.

When included, display subsystem 205 may be used to present a visual representation of data held by data-holding subsystem 204. As the herein described methods and processes change the data held by the data-holding subsystem 204, and thus transform the state of the data-holding subsystem 204, the state of display subsystem 205 may likewise be transformed to visually represent changes in the underlying data. Display subsystem 205 may include one or more display devices utilizing virtually any type of technology. Such display devices may be combined with logic subsystem 203 and/or data-holding subsystem 204 in a shared enclosure, or such display devices may be peripheral display devices.

When included, communication subsystem 206 may be configured to communicatively couple server 102 with one or more other computing devices, such as consumer device 120 and/or artist device 110. Communication subsystem 206 may include wired and/or wireless communication devices compatible with one or more different communication protocols. As non-limiting examples, communication subsystem 206 may be configured for communication via a wireless telephone network, a wireless local area network, a wired local area network, a wireless wide area network, a wired wide area network, etc. In some embodiments, communication subsystem 206 may allow server 102 to send and/or receive messages to and/or from other devices via a network such as the public Internet. For example, communication subsystem 206 may communicatively couple server 102 with consumer device 120 and/or artist device 110 via network 101. In some examples, network 101 may be the public Internet.

Consumer device 120 may include a logic subsystem 221 and a data-holding subsystem 224. Consumer device 120 may optionally include a display subsystem 225, communication subsystem 226, and/or other components not shown in FIG. 2A. For example, consumer device 120 may also optionally include user input devices such as keyboards, mice, game controllers, cameras, microphones, and/or touch screens.

Logic subsystem 221 may include one or more physical devices configured to execute one or more instructions. For example, logic subsystem 221 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 221 may include one or more processors that are configured to execute software instructions. Additionally or alternatively, the logic subsystem 221 may include one or more hardware or firmware logic machines configured to execute hardware or firmware instructions. Processors of the logic subsystem 221 may be single or multi-core, and the programs executed thereon may be configured for parallel or distributed processing. The logic subsystem 221 may optionally include individual components that are distributed throughout two or more devices, which may be remotely located and/or configured for coordinated processing. One or more aspects of the logic subsystem 221 may be virtualized and executed by remotely accessible networking computing devices configured in a cloud computing configuration.

Data-holding subsystem 224 may include one or more physical, non-transitory devices configured to hold data and/or instructions executable by the logic subsystem 221 to implement the herein described methods and processes. When such methods and processes are implemented, the state of data-holding subsystem 224 may be transformed (for example, to hold different data). As such, data-holding subsystem 224 may include block chain 103, and consumer wallet 121. When a new block on the block chain 103 is published, the state of data-holding subsystem 224, specifically the block chain 103 may be transformed, so that the new block in the block chain 103 is incorporated in the data held in the data-holding subsystem 224. Further, transactions involving the transfer of cryptocurrency from the consumer device 120 may include the transformation of data held in the consumer wallet 121 of the data-holding subsystem 224.

Data-holding subsystem 224 may include removable media and/or built-in devices. Data-holding subsystem 224 may include optical memory (for example, CD, DVD, HD-DVD, Blu-Ray Disc, etc.), and/or magnetic memory devices (for example, hard drive disk, floppy disk drive, tape drive, MRAM, etc.), and the like. Data-holding subsystem 224 may include devices with one or more of the following characteristics: volatile, nonvolatile, dynamic, static, read/write, read-only, random access, sequential access, location addressable, file addressable, and content addressable. In some embodiments, logic subsystem 223 and data-holding subsystem 224 may be integrated into one or more common devices, such as an application-specific integrated circuit or a system on a chip.

When included, display subsystem 225 may be used to present a visual representation of data held by data-holding subsystem 224. As the herein described methods and processes change the data held by the data-holding subsystem 224, and thus transform the state of the data-holding subsystem 224, the state of display subsystem 225 may likewise be transformed to visually represent changes in the underlying data. Display subsystem 225 may include one or more display devices utilizing virtually any type of technology. Such display devices may be combined with logic subsystem 223 and/or data-holding subsystem 224 in a shared enclosure, or such display devices may be peripheral display devices. Thus, display subsystem 225, may present a visual representation of the user interface 105.

When included, communication subsystem 226 may be configured to communicatively couple consumer device 120 with one or more other computing devices, such as server 102. Communication subsystem 226 may include wired and/or wireless communication devices compatible with one or more different communication protocols. As non-limiting examples, communication subsystem 226 may be configured for communication via a wireless telephone network, a wireless local area network, a wired local area network, a wireless wide area network, a wired wide area network, etc. In some embodiments, communication subsystem 226 may allow consumer device 120 to send and/or receive messages to and/or from other devices, such as server 102 and artist device 110, via a network 101 such as the public Internet.

Similarly, artist device 110 may include a logic subsystem 213 and a data-holding subsystem 214. Artist device 110 may optionally include a display subsystem 215, communication subsystem 216, and/or other components not shown in FIG. 2. For example, artist device 110 may also optionally include user input devices such as keyboards, mice, game controllers, cameras, microphones, and/or touch screens.

Logic subsystem 213 may include one or more physical devices configured to execute one or more instructions. For example, logic subsystem 213 may be configured to execute one or more instructions that are part of one or more applications, services, programs, routines, libraries, objects, components, data structures, or other logical constructs. Such instructions may be implemented to perform a task, implement a data type, transform the state of one or more devices, or otherwise arrive at a desired result.

Logic subsystem 13 may include one or more processors that are configured to execute software instructions. Additionally or alternatively, the logic subsystem 213 may include one or more hardware or firmware logic machines configured to execute hardware or firmware instructions. Processors of the logic subsystem 213 may be single or multi-core, and the programs executed thereon may be configured for parallel or distributed processing. The logic subsystem 213 may optionally include individual components that are distributed throughout two or more devices, which may be remotely located and/or configured for coordinated processing. One or more aspects of the logic subsystem 213 may be virtualized and executed by remotely accessible networking computing devices configured in a cloud computing configuration.

Data-holding subsystem 214 may include one or more physical, non-transitory devices configured to hold data and/or instructions executable by the logic subsystem 213 to implement the herein described methods and processes. When such methods and processes are implemented, the state of data-holding subsystem 214 may be transformed (for example, to hold different data). As such, data-holding subsystem 214 may include block chain 103, and artist wallet 111. When a new block on the block chain 103 is published, the state of data-holding subsystem 214, specifically the block chain 103 may be transformed, so that the new block in the block chain 103 is incorporated in the data held in the data-holding subsystem 214. Further, transactions involving the transfer of cryptocurrency to the artist device 110 may include the transformation of data held in the artist wallet 111 of the data-holding subsystem 214.

Data-holding subsystem 214 may include removable media and/or built-in devices. Data-holding subsystem 214 may include optical memory (for example, CD, DVD, HD-DVD, Blu-Ray Disc, etc.), and/or magnetic memory devices (for example, hard drive disk, floppy disk drive, tape drive, MRAM, etc.), and the like. Data-holding subsystem 214 may include devices with one or more of the following characteristics: volatile, nonvolatile, dynamic, static, read/write, read-only, random access, sequential access, location addressable, file addressable, and content addressable. In some embodiments, logic subsystem 213 and data-holding subsystem 214 may be integrated into one or more common devices, such as an application-specific integrated circuit or a system on a chip.

When included, display subsystem 215 may be used to present a visual representation of data held by data-holding subsystem 214. As the herein described methods and processes change the data held by the data-holding subsystem 214, and thus transform the state of the data-holding subsystem 214, the state of display subsystem 215 may likewise be transformed to visually represent changes in the underlying data. Display subsystem 215 may include one or more display devices utilizing virtually any type of technology. Such display devices may be combined with logic subsystem 213 and/or data-holding subsystem 214 in a shared enclosure, or such display devices may be peripheral display devices. Thus, display subsystem 215, may present a visual representation of the user interface 105.

When included, communication subsystem 216 may be configured to communicatively couple artist device 110 with one or more other computing devices, such as server 102. Communication subsystem 216 may include wired and/or wireless communication devices compatible with one or more different communication protocols. As non-limiting examples, communication subsystem 216 may be configured for communication via a wireless telephone network, a wireless local area network, a wired local area network, a wireless wide area network, a wired wide area network, etc. In some embodiments, communication subsystem 216 may allow artist device 110 to send and/or receive messages to and/or from other devices, such as server 102 and consumer device 120, via network 101 such as the public Internet.

Thus server 102, consumer device 120, and artist device 110, may each represent computing devices which may generally include any device that is configured to perform computation and that is capable of sending and receiving data communications by way of one or more wired and/or wireless communication interfaces. Such devices may be configured to communicate using any of a variety of network protocols. For example, consumer device 120 may be configured to execute a browser application that employs HTTP to request information from server 102 and then displays the retrieved information to a user on a display. Example interfaces that may be delivered to consumer device 120 from server 102 in such a manner and displayed, for example, on display subsystem 225 are described further herein and with regard to FIGS. 7B-7H. Similarly artist device 110 may be configured to execute a browser application that employs HTTP to request information from server 102 and then displays the retrieved information to a user on a display. Example interfaces that may be delivered to artist device 110 from server 102 in such a manner and displayed, for example, on display subsystem 215 are described further herein and with regard to FIG. 7A and FIGS. 7F-7H.

Server 102 may collect and process data from artist device 110 and/or from consumer device 120. A consumer may create a consumer account which may be stored on the user account module 235. The consumer account may include information input by the user such as email address, mailing address, password, song preferences, and/or a history of songs streamed and/or downloaded by the consumer. Consumer information may be transferred to server 102 via network 101, and may be stored in the data-holding subsystem 204 of the server 102.

Similarly, an artist may create an artist account which may be stored on the user account module 235. The artist account may include information input by the artist such as email address, password, a deduction percentage, and/or a history of songs uploaded to the server 102 by the artist via artist device 110 and network 101. Artist information may be transferred to server 102 via network 101, and may be stored in the data-holding subsystem 204 of the server 102.

Server 102 may analyze the data collected from consumer device 120 and artist device 110, for example, using data analysis techniques and/or artificial intelligence techniques. For example, data collected from the consumer device 120 and/or artist device 110 may be analyzed to determine the time since the most recent payment of a subscription fee as described below with reference to the method in FIGS. 4B and 6.

Thus, artist device 110, and consumer device 120 may be in communication with one another via network 101. An artist may upload songs to the data-holding subsystem 204 of the server 102 by way of displays presented on the display subsystem 215 of the artist device 110. Specifically, a user interface 105 may be visually represented on the display subsystem 215 to the artist, which the artist may then manipulate to upload songs to the data-holding subsystem 204, where the songs may be stored in non-transitory memory on the data-holding subsystem, such as in the music database 234. Consumer, may then access those songs stored on the data-holding subsystem, via inputs on the consumer device 120. Thus, user interface 105 may be visually represented on the display subsystem 225 to the consumer, which the consumer may then manipulate to download and/or stream songs downloaded to the data-holding subsystem 204 from the artist device 110. In order to stream songs stored on the data-holding subsystem 204, the consumer may have to pay a subscription fee using cryptocurrency. A portion of that subscription fee may be transferred directly from the consumer device 120 to the artist device 110 via network 101 based on a proportion of the songs streamed and/or downloaded to the consumer device 120 that were uploaded to the data-holding subsystem by the artist device 110. Said another way, a consumer may download and/or stream songs from a plurality of artists, where each of the plurality of artists may have uploaded songs to the data-holding subsystem 204 from separate artist devices. As such, the amount of the subscription fee that may be transferred to each artist device may depend on the proportion of songs streamed to the consumer device 120 belonging to each artist. In other examples, the subscription fee may be paid by a third party investor, and not by the artist.

Moving on to FIG. 3, it shows another example embodiment of the online music marketplace 100. As such, components of the online music marketplace 100 already described in FIGS. 1 and 2, may not be described again in detail in the description of herein of FIG. 3. Specifically, FIG. 3 shows the flow of digital information between the consumer wallet 121 and the artist wallet 111 via network 101. As such, FIG. 3 shows different types of transactions that may occur between the artist device 110 and the consumer device 120.

As described above with reference to FIG. 1, the consumer wallet 121, and artist wallet 111 may comprise both public keys and private keys that represent ownership of one or more cryptocurrencies and/or digital goods and services. The artist wallet 111 may comprise cryptocurrency 310, which may include bitUSD, bitEUR, bitCNY, etc. Further, FIG. 3 shows an example, immediately after an artist creates an artist account, and artist tokens 312 are transmitted to the artist wallet 111 in the manner described above with reference to FIGS. 1 and 2. Thus, as shown in FIG. 3, after an artist creates an artist account, an artist desired number of artist tokens 312 may be generated and assigned to the artist wallet 111 via network 101. Further, the artist wallet 111 may include digital merchandise 314 such as digital tickets, promotional offers, VIP passes, etc. The cryptocurrency 310, artist tokens 312, and digital merchandise 314 may all have private and public keys. Thus, the cryptocurrency 310, artist tokens 312, and digital merchandise 314 may be transferred directly to the consumer wallet 121 via network 101 upon a digital signature from the artist wallet 111.

After initially receiving the artist tokens 312 from the token creation module 231 (shown in FIG. 1), the artist may create a sell order, which may be broadcast to the consumer device 120, and any other consumer devices in the network 101. The sell order may comprise a first piece of digital information corresponding to the amount and/or number of artist tokens 312, the artist wishes to sell from their artist wallet 111. The sell order may also comprise a second piece of digital information corresponding to a minimum amount the artist is willing to sell the artist tokens 312 for. In some example, the total number of artist tokens 312, may be published to the block chain 103 (shown in FIGS. 1 and 2), so that each consumer is aware of the total number of artist tokens 312.

A consumer may create a buy order for a portion or all of the artist tokens 312 offered in the sell order. The buy order may comprise a first piece of digital information corresponding to an amount the consumer is willing to spend on the artist tokens 312. Additionally or alternatively, the first piece of digital information may correspond to an amount the consumer is willing to buy each artist token for. As such the price of an artist token may be set by principles of supply and demand. Said another way, the price of an artist token may be highest price consumers are willing to buy the artist tokens 312 for. In other examples, the price of an artist token may be set by the sell order of the current owner of that artist token. Thus, the price of an artist token may be an amount the current owner of that token is willing to sell the artist token for.

As shown at block 304 in FIG. 3, artist tokens 312, may be purchased by a consumer, and the ownership of the artist tokens 312 may be changed from the artist wallet 111 to the consumer wallet 121 in exchange for cryptocurrency 310. Thus, cryptocurrency may be transferred from the consumer wallet 121 to the artist wallet 111 in exchange for artist tokens 312. As such, in some examples, the artist may increase their cryptocurrency, and therefore generate income, by selling their artist tokens 312 to consumers. Consumers may then trade, buy, sell, and exchange their artist tokens 312 to other consumers and/or artists.

Consumers may also purchase digital merchandise 314 such as digital tickets, digital promotional offers such as backstage VIP passes, etc., in the same manner as described above for the artist tokens 312 as shown at block 306 in FIG. 3. As will be discussed in greater detail below with reference to FIGS. 4-6, a portion of the cryptocurrency received by the artist wallet 111 may be used to purchase and destroy a portion of the artist tokens 312.

Further, consumers may download and/or stream songs 316 that may be stored on the music database 234. Thus, as described above with reference to FIGS. 1 and 2, an artist may upload songs 316 to the music database 234 from their artist device 110. The songs 316 from that artist may therefore be stored in non-transitory memory on the music database 234. A consumer may then stream and/or download songs 316 stored on the music database 234 via the consumer device 120. As described in greater detail below with reference to FIGS. 4-6, consumers may pay a subscription fee in the form of cryptocurrency, which may be at regular time intervals. A portion of that subscription fee may be transferred from the consumer wallet 121 to the artist wallet 111 based on the number of songs 316 streamed by the consumer on the consumer device 120.

In this way, cryptocurrency 310, artist tokens 312, and digital merchandise 314, may be transferred between the consumer wallet 121 and the artist wallet 111 via the network 101. The exchange of cryptocurrency 310, artist token 312, and digital merchandise 314 may hereinafter be referred to as digital transactions. Thus, artists and consumers may engage in digital transactions, which may comprise the exchange of one or more of songs 316, cryptocurrency 310, artist tokens 312, and digital merchandise 314. Further, all digital transactions may be stored on the block chain 103, so that all digital transactions may be recorded and verified by each consumer and artist device in the online music marketplace 100.

Turning now to FIGS. 4A-4C, they show a swim-lane flow chart illustrating an example method 400 for executing the digital transactions described above with reference to FIG. 3. In particular, method 400 illustrates how server 102 interacts with consumer device 120 and artist device 110 to provide music streaming and/or downloading capabilities in the online music marketplace 100 shown above with reference to FIGS. 1 and 2.

Method 400 in FIG. 4A comprises an artist creating an account, and receiving artist tokens, which may then be bought, sold, traded, exchanged via the network 101 shown in FIGS. 1 and 2. Thus, method 400 may begin at 418, and artist preferences may be received on the artist device 110, upon creation of an artist account. Artist preferences may include a desired number of artist tokens (e.g., artist tokens 312 shown in FIG. 3), digital merchandise (e.g., digital merchandise 314 shown in FIG. 3), a deduction percentage, etc. The deduction percentage may be a percentage of all cryptocurrency (e.g., cryptocurrency 310 shown in FIG. 3) received by the artist device 110 that may be used to purchase and destroy the artist tokens. In some examples, the deduction percentage may be a percentage of cryptocurrency received by the artist device 110 from only digital transactions involving songs (e.g., downloading and/or streaming of songs) digital merchandise, physical merchandise, etc. Thus, in some examples, the deduction percentage may not be applied to cryptocurrency earned by the artist from selling artist tokens. Thus, income generated by an artist (e.g. cryptocurrency transferred to the artist device 110), whether that income be from the download and/or streaming of the artist songs on the consumer device 120, and/or selling of digital merchandise to the consumer device 120, may be used to destroy a portion of the artist tokens. The artist may set the deduction percentage, but one the artist has input the deduction percentage to the artist device, the deduction percentage may not be changed.

After receiving the artist preferences at 418, method 400 may continue to 420 which comprise transmitting the artist preferences to the server 102. Thus the method at 420 may comprise sending digital information corresponding to the artist preferences via the network to the server 120. The server 102 may receive and/or store the artist preferences on a user account module (e.g., user account module 235 shown in FIGS. 1 and 2) at block 421. Thus the method 400 at 421 may include storing the artist preferences in non-transitory memory on the server 102. Method 400 may then continue to 422 and generate the desired amount of artist tokens indicated by the artist in the artist preferences. Thus, the method 400 at 422 may include generating the desired number of artist tokens by way of a token creation module (e.g., token creation module 231 shown in FIG. 1). The token creation module may be a random number generator, which may assign a string of randomly created digits to each artist token that may distinguish artist tokens from one another. Further, all of the artist tokens generated may be assigned a unique ID, which may be in the form of a hash, or digital string of numbers and/or digits. Each artist and their associated artist tokens may all be assigned a unique ID, and as such the unique ID may be used to distinguish the artist tokens of different artists.

Proceeding from 422, method 400 may comprise transmitting the desired amount of artist tokens to the artist device 110. Further, the method 400 may additionally comprise transmitting the number of artist tokens transmitted to the artist device 110 at 424, and/or the deduction percentage to the consumer device 120 at 426. Thus, in some examples, all consumer devices in the network, may receive digital information relating to the total number of artist tokens assigned to a particular artist, and the deduction percentage of that artist. Said another way, each consumer device 120 may receive digital information corresponding to the percentage of an artist's income that may be used to destroy that artist's tokens. Thus, at 431, the consumer device 120 may receive the artist's deduction percentage. The artist's deduction percentage may be stored on a block chain (e.g., block chain 103 shown in FIGS. 1-2), where the block chain may be either partially or wholly stored in non-transitory memory on the consumer device 120 and on the artist device 110.

Returning to 424, after transmitting the desired amount of artist tokens to the artist, method 400 may proceed to 428, which comprises receiving the desired amount of artist tokens and storing the digital information relating to the artist tokens in an artist wallet on the artist device 110 (e.g., artist wallet 111 shown in FIGS. 1-3). The artist wallet may comprise private keys associated with the artist tokens. Further the artist wallet may be the only wallet containing the private keys for the artist tokens. As such, the artist wallet may comprise all of the artist tokens generated at 422. However, in other examples, a portion of the artist tokens generated at 422 may be transmitted to the consumer device 120, and as such, a consumer wallet (e.g., consumer wallet 121 shown in FIGS. 1-3) may comprise private keys corresponding to ownership of a portion of the artist tokens generated at 422. Thus, in some examples all of the artist tokens generated at 422 may be assigned a public key destination of the artist wallet, and all artist tokens may be transferred to the ownership of the artist. However, in other examples, a portion of the artist tokens generated at 422 may be assigned a public key destination of the consumer wallet, and those artist tokens may be transferred to the ownership of the consumer.

After receiving the artist tokens at 428, method 400 may continue to 430, which comprises receiving an artist token sell order from the artist. Thus, as described above with reference to FIG. 3, the artist via interaction with the artist device 110 and the user interface may generate a sell order. The sell order may include a number of artist tokens that the artists wishes to sell, and/or a minimum amount that the artist wishes to sell the tokens for. Further, the sell order may additionally include a sell order for digital and/or physical merchandise.

The method 400 may then comprise transmitting the sell order from the artist device 110 to the consumer device 120 at 432 via the network. The consumer device 120 may then receive the sell order at 433. A consumer may request to purchase one or more artist tokens, digital merchandise, etc. from the artist device 110. As such, the consumer may request a buy order via the consumer device 120 and the user interface. Example displays that may be presented to the consumer on consumer device 120 in response to a buy order from the consumer are shown below with reference to FIGS. 7D and 7E.

The artist device 110 may receive the buy order from the consumer device 120 at 434. Once the buy and sell orders have been received by the consumer device 120 and the artist device 110, method 400 may continue to 436 and 438 and determine if the buy order matches the sell order on the artist device 110 and consumer device 120 respectively. Thus each device in the network may independently verify the transaction. The process of determining whether the buy order matches the sell order may include determining that the artist tokens and/or merchandise that the consumer device 120 is requesting to purchase from the artist device 110 have not already been sold from the artist device 110 to another consumer device 120. In another example, the method at 436 and 438 may comprise determining if the buy order from the consumer device 120, offers the highest payment of any user devices on the network. Said another way, artist tokens may be sold to the highest buy order. Thus artist tokens may be transferred with decreasing priority to buy orders of decreasing cryptocurrency. As such, in certain examples, the price of artist tokens may be set by highest current buy order.

However, in other examples, the server 102 may comprise instructions for setting the price of the artist tokens based on the supply and demand of the tokens. Thus, in some examples, the price of the artist tokens may be adjusted based on the rate of purchase of the artist tokens, and may be adjusted by computer readable instructions of the server 102.

All digital transactions may be published to the block chain, and as such all consumer devices may have a record of the value of the artist token, based on the most recent transactions involving the artist tokens. If it is determined at either 436 or 438 that the buy order does not match the sell order, which may occur if the artist tokens have already been sold to another consumer device 120, then method 400 may continue to 440 and 441, respectively and the transaction is not completed. Thus, at 440 and 441, artist tokens and/or cryptocurrency are not transferred between the consumer device 120 and the artist device 110.

However, if the buy order matches the sell order at both 436 and 438, then method 400 may continue to 442 and 439 respectively. The method at 442 may comprise transmitting cryptocurrency from the consumer device 120 to the artist device 110, and receiving artist tokens and/or merchandise from the artist device 110 to the consumer device. Further, the method at 442 may include transmitting the artist tokens and/or merchandise to the consumer device 120 from the artist device 110, and receiving a portion of the transmitted cryptocurrency from the consumer device 120 based on the deduction percentage. As such, 436 and 438 may be executed simultaneously. Similarly, 442 and 439 may additionally or alternatively be executed simultaneously. As such, the execution of 442 and 439 may represent a digital transaction, where cryptocurrency is transferred from the consumer device to the artist device 110, and artist tokens and/or merchandise are transferred from the artist device 110 to the consumer device 120. Since, the artist tokens and the cryptocurrency may comprise public and private keys, the exchange of cryptocurrency for artist tokens may comprise a change in the most recent public key address of the cryptocurrency and/or artist tokens, and a change in their respective private keys.

Thus, the artist may transmit the artist tokens from the artist device 110 to the consumer device 120, by assigning the artist tokens the new public key of the consumer device 120, together with the private keys of those artist tokens stored on the artist device 110. Similarly, the consumer may transmit cryptocurrency to the artist device 110 from the consumer device 120, by assigning the cryptocurrency the new public key of the artist device 110, together with the private keys from the consumer device 120. However, the private keys are never published to the block chain. Only the public keys are published to the block chain. Therefore, upon completion of the transaction, at 439 and 442, the transaction may be recorded in the block chain. More specifically, the digital information of the cryptocurrency, and artists tokens involved in the transaction at 442 and 439 may be transformed, so that the current public key of the cryptocurrency is now associated with the artist device 110, and the current public key of the artist token is now associated with the consumer device 120. As such, the block chain may be updated to include the transaction at 442 and 439, on all devices where the block chain is stored in non-transitory memory.

However, at 442 in examples where the transaction at 442 and 439 does not involve artist tokens, only a portion of the cryptocurrency transmitted by the consumer device 120 may be received by the artist device 110. Thus, if the consumer device 120 is purchasing merchandise and not artist tokens from the artist device 110, then the artist device 110 may not receive the full amount of cryptocurrency transferred from the consumer device 120 in exchange for the merchandise. This is because at 444 the method 400 may comprise destroying a portion of the artist tokens stored on the artist device 110. The number of artist tokens destroyed at 444 may be based on the deduction percentage determined by the artist at 418. Thus, the number of artist tokens destroyed at 444 may be based on the current value of the artist tokens, the deduction percentage, and the amount of cryptocurrency transmitted at 439.

The deduction percentage may be a decimal value between 0 and 1. In such examples, the deduction percentage may be multiplied by the cryptocurrency transmitted at 439. The product may be the amount of cryptocurrency that is deducted from the amount of cryptocurrency transmitted to and received by the artist device at 442. Further, the deducted amount may then be used to purchase and destroy artist tokens, in the manner described above at 438 and 436. Thus, the artist tokens may be purchased using the deducted amount, where the number of purchased and destroyed artist tokens may be based on the current value at which artist tokens are being bought. Further, the process of destroying the artist tokens at 444 may comprise deleting the public and private keys associated with the artist tokens. In other examples, the process of destroying the artist tokens at 444 may comprise assigning a public and/or private key to the artist token that is not associated with any artist device 110 and/or consumer device 120 in the network 101. Thus, destroyed artist tokens may be assigned to a location that cannot be accessed by any consumer device 120 or artist device 110 in the network 101. Without the public key, the artist tokens are no longer published and recognized on the block chain. Thus, after executing 444 the number of artist tokens may decrease. As a result of the decrease in artist tokens, the value of the artist token may increase.

The number of artist tokens destroyed at 444 may then be transmitted to and received by the consumer device 120 at 446. Said another way, the consumers in the network, may be notified of the decrease in the number of artist tokens as a result of the transfer of cryptocurrency from the consumer device 120 to the artist device 110 and the resulting destruction of artist tokens. The number of tokens destroyed at 444 may be referred to herein as a burn amount.

Method 400 continues at FIG. 4B. Specifically, the method 400 in FIG. 4B may be used to allow a consumer to stream artist songs. In some examples, the consumer may pay a subscription fee at a regular time interval in exchange for the right to stream songs. In other examples, the consumer may not pay the subscription fee, but the subscription fee may instead be paid by a third party investor. Method 400 may continue to 450 on FIG. 4B from FIG. 4A, which comprises receiving songs from the artist. Thus, at 450 artist songs (e.g., songs 316 shown in FIG. 3), may be downloaded to the artist device 110. Specifically, the songs may be stored as digital data on non-transitory memory (e.g., data-holding subsystem 214 shown in FIG. 2) of the artist device 110. Method 400 may then continue to 452 which comprise transmitting the songs to the server 102. Thus, the method 400 at 452 may comprise sending the digital data representing the songs, to the server 102 via a network (e.g., network 101 shown in FIGS. 1-2).

Next, at 454, the server 102 may receive and/or store the songs on a music database (e.g., music database 234 shown in FIGS. 1-2.). Thus, the method at 454 may comprise storing the digital data corresponding to the songs in non-transitory memory on the server 102. Once the songs have been stored in non-transitory memory on the server 102, a consumer may request to stream one or more of the songs at 456. Thus, a consumer may request to stream one of the songs stored on the music database via inputs on the consumer device 120. Specifically, the server 102, may generate a user interface (e.g., user interface 105 shown in FIGS. 1-2) which may be visually represented to a consumer on the consumer device 120. As an example, the consumer may interact with the user interface via a web page and/or mobile app. Thus, the consumer may access the user interface which may be a web page through a search engine. The user may then provide inputs via the consumer device 120 to the user interface corresponding to a request for one or more of a search, stream, and/or download of a song.

In response to the consumer request for one or more of a search, stream, and/or download of a song, the consumer device 120 may transmit a consumer request to the server 102 at 458. The consumer request may be sent by a communication subsystem (e.g., communication subsystem 226 shown in FIG. 2) to the server 102 via the network. The server may in turn receive the consumer request at 460. A logic system of the server 102 (e.g., logic subsystem 203 shown in FIG. 2) may in turn execute the consumer request received at and transmit the consumer requested song 462. The execution of the consumer request at 462 may comprise parsing through the data corresponding to the songs stored in the music database, and determining the one or more songs matching the consumer request. The matching of the consumer request to songs stored in the music database may comprise one or more matching algorithms. Upon receipt of the consumer requested songs from the server 102, the consumer device 120 may play and/or store the consumer requested songs at 464. In this way, a consumer may listen to one or more songs uploaded by an artist to the server 102.

At regular time intervals, a subscription fee may be transmitted to the server 102, and then may be distributed to one or more artists based on the number of songs streamed by one or more consumers from each artist. The subscription fee may be cryptocurrency. In some examples the regular time interval may be a month. In other examples, the regular time interval may be a set number of days. In some examples, the subscription fee may be paid by the consumer. Thus, the consumer may pay the subscription fee daily, monthly, weekly, quarterly, etc.

As such, the method 400 at 466 may comprise transmitting the subscription fee from the consumer device 120. In some examples, method 400 may continue from 464 to 466. However, in other examples, the consumer may pay the subscription fee before streaming any songs. Thus, in such examples, 466 may be executed before 456.

However, it is important to note that in other examples, the subscription fee may be paid and transmitted to the server 102 from a third party investor. The third party investor may be an individual, business, corporation, organization, etc., that may provide currency (e.g., cryptocurrency) to the online music marketplace 100, and specifically to server 102. Thus, in some examples, the consumer may not pay the subscription fee. In examples, where the consumer pays the subscription fee, the subscription fee may be a pre-set, fixed amount. In examples where the subscription fee is paid by a third party investor, the amount of the subscription fee may be based on the number of third party investors, and the number of consumers. Thus, the subscription fee may be the total amount of currency transmitted to the server 102 from one or more third party investors, divided by the number of consumers streaming artist songs via the network 101.

Method 400 may then proceed to 468, which comprises receiving the subscription fee. As noted above, the subscription fee may be received from the consumer device 120 and/or one or more third party investors. After receiving the subscription fee at 468, method 400 may then continue to 470 which comprise determining the time since the last subscription fee payment. Then, method 400 may proceed to 472, which comprises determining if the subscription period has expired. Determining if the subscription period has expired may include determining if the time since the last subscription fee payment is greater than or equal to a threshold. The threshold may be the regular time interval. Thus, if the amount of time elapsed since the most recent subscription fee payment has not reached the amount of time in the regular time interval, then the method 400 may return.

However, if it is determined that the amount of time since the last subscription fee payment has reached the threshold time interval, then method 450 may continue to 474 and calculate and/or estimate the artist's share of the consumer subscription fee payment. The calculation of the artist's share of the consumer subscription fee payment may be based on the total number of songs streamed on the consumer device 120 since the most recent payment of the subscription fee, and the proportion of the songs that were produced and uploaded to the server 102 from the artist device 110. In the description hereinafter, artist produced songs, may be songs created by and uploaded to the server 102 by an artist via artist device 110. Thus, an artist produced song may be any song that the artist has legal right to the ownership, production, distribution, etc. of that song.

The artist's share of the consumer subscription fee may be calculated by first determining the ratio of the songs streamed on the consumer device 120 that were the artist produced songs of a single artist to the total number of songs streamed on the consumer device 120 since the most recent subscription fee payment. As such, if a consumer device 120 streams the songs only produced from a single artist, then the artist may receive approximately the entire subscription fee payment from the consumer device 120. In this way, for a consumer who streams songs from two different artists, but streams more songs from a first artist than from the second artist, the first artist may receive a greater share of the subscription fee payments than the second artist.

Method 400 may then proceed to 476 which comprise transmitting the artist's share of the subscription fee payment to the artist device 110. Thus, the artist's share of the subscription fee payment calculated in 474 may be encoded in a digital message and sent to the artist device 110.

Next, at 478, the method 400 may comprise receiving and/or storing the net income cryptocurrency in the artist wallet, in the manner described above at 442 in FIG. 4A. Further, in the manner described above at 444, the method 400 may continue to 480 which may comprise destroying a portion of the received cryptocurrency based on the deduction percentage. The, method 400 may proceed to 482 which comprises transmitting the burn amount to the consumer device 120. The consumer device 120 may then receive the burn amount at 484.

In this way the subscription fee may be transmitted to the server from one or more of the consumer and third party investors. The cryptocurrency of the subscription fee may then be held on the server 102, until the subscription period expires. The subscription fee may then be divided and apportioned to the artists whose songs were streamed on the consumer device 120 since the most recent subscription fee payment to the server 102.

In this way, the method 400 in FIG. 4B may in some examples comprise transferring cryptocurrency from the consumer device 120 to the artist device 110 based on the number of artist songs streamed by the consumer via the consumer device 120.

Turning now to FIG. 4C, it continues with method 400 from FIG. 4B. The method 400 in FIG. 4C may be executed to transfer payment directly from the consumer device 120 to the artist device 110 in exchange for the consumer downloading one or more of the artist's songs.

A consumer request for the download of one or more songs may be received at 485. Upon receipt of the consumer request, the method 400 may comprise transmitting the consumer request to server 102 and simultaneously transmitting cryptocurrency to the artist device 110. The amount of cryptocurrency transmitted to the artist device 100 may be based on the number of songs requested by the consumer for downloading onto the consumer device 120.

After transmitting the cryptocurrency to the artist device 110 at 486, the method 400 may continue to 488 which may comprise receiving the cryptocurrency. After transmitting the consumer request to server 102, the consumer request may be received at the server 102 at 490. Thus, the method 400 at 490 may comprise receiving the consumer request and confirming the transaction on the block chain. Said another way, the server 102, may monitor transactions occurring on the block chain, and at 490, may verify that payment for the consumer requested songs was transferred to the artist device 110 from the consumer device 120. Upon confirmation, of the transaction at 490, method 400 may then proceed to 492, which may comprise transmitting the consumer requested songs to the consumer device 120 in a similar manner as described above at 462. Thus, the method 400 at 492 may comprise parsing through a database of songs stored on the server 102 in non-transitory memory, and selecting the one or more songs that match to the consumer requested songs. Method 400 may then proceed from 492 to 494, which comprises receiving and downloading the consumer requested songs. Thus, at 494, the consumer requested songs, may be received at the consumer device 120, and may be downloaded and stored in non-transitory memory on the consumer device 120.

Returning to 488, after receiving the cryptocurrency, method 400 may continue to 496, which comprises destroying artist tokens based on the deduction percentage in a similar manner as described above at 444 in FIG. 4A. Further the method 400 at 496 may comprise transmitting the burn amount to consumer device 120 as described above at 444. Then at 498, the method may comprise receiving the burn amount 498 in a manner similar that described above at 446. Method 400 may then return.

In this way, consumers may download and/or stream songs produced by artists and uploaded to the server 102. At a regular time interval a consumer may pay a subscription fee which may be a pre-set amount, and that subscription may be divided and distributed to artists whose songs the consumer streamed since the their most recent subscription fee payment based on the number of songs streamed to by the consumer from each artist. Consumer may also download songs from the server 102, and may pay artists directly for those download. Further, consumers may purchase artist tokens and/or digital merchandise from artists. In each digital transaction, where a consumer transfers cryptocurrency to the artist in exchange for songs and/or merchandise, a proportion of that cryptocurrency may be used to buy and destroy artist tokens. In this way, the number of artist tokens may decrease with increases in the number of transactions involving that artist. Thus, increases in one or more of the number of songs streamed and/or downloaded by consumers, and purchases of digital merchandise from the artist, may reduce the number of artist tokens in existence, and therefore increase the value of each artist token.

As a result, consumers who stream fewer songs from fewer artists, may transmit a higher proportion of their subscription fee to each artist they streamed songs from, than consumers who streamed and/or downloaded more songs and/or from a greater number of artists. Therefore, the impact that a consumer may have on the value of an artist's tokens may increase with decreases in the number of songs streamed by that consumer from other artists.

Turning now to FIG. 5, it shows a method 500 for an online music marketplace, such as the online music marketplace 100 shown in FIG. 1. Instructions for carrying out method 500 may be stored in the memory of a computer and/or server (e.g., data holding subsystem 204 of server 102 from FIGS. 1-2). As such, method 500 may be carried out by a logic system (e.g., logic subsystem 203 from FIGS. 1-2) of the computer and/or server.

Method 500 begins at 502 which comprise an artist creating an account, and receiving a fixed number of unique artist tokens. Thus, as described above with reference to FIG. 4, the method 500 at 502 may include receiving a deduction percentage form the artist, and a desired number of tokens from the artist. As such, the method at 502 may include generating the desired number of artist tokens, and assigning each of them a unique artist ID, which may be in the form of a hash, or public key which may be published to a block chain.

Method 500 may then proceed to 504 which comprise the artist uploading songs and/or digital merchandise to the server and creating a sell order on a portion or all of the tokens.

Method 500 may then proceed to one or more of 512, 510, and 506. At 512, a consumer may request to purchase one or more of the artist's digital merchandise. At 510, a consumer may request to purchase one or more of the artist tokens. At 506, a consumer may request to stream and/or download songs uploaded by the artist at 504. As described above with reference to FIG. 4B, the method 500 may then proceed to 508 from 506 and calculate a first portion of the artist's gross income based on the streaming history of the consumer. Specifically, as discussed above in FIG. 4B, the proportion of the subscription fee transferred to the artist as gross income may be based on the number of songs streamed from that artist relative to the total number of songs streamed. Method 500 may then proceed from one or more of 512, and 508 to 514, which comprises appropriating a portion of the artist income to destroying artist tokens based on the deduction percentage. Thus, the number of artist tokens destroyed may be based on the pre-set deduction percentage set by the artist at 502. Further the amount of tokens destroyed at 514 may be determined in the manner described above at block 444 of FIG. 4A.

Method 500 may then proceed to 516 from one or more of 514 and 510. The method 500 at 516 may comprise completing the transaction on the block chain. Thus, the transfer of cryptocurrency from the consumer to the artist may be recorded on the block chain. Further, if the transaction did not involve the exchange of artist tokens from the artist to the consumer, then the destruction of the artist tokens at 514 may additionally be recorded on the block chain.

After the digital transaction are recorded on the block chain, artist tokens and/or digital merchandise purchased by the consumer and verified as a transaction at 516, may then be bought, sold, traded, amongst other consumers at 518.

Turning now to FIG. 6, it shows a method for determining the proportion of a consumer subscription fee transferred to an artist. Instructions for carrying out method 600 may be stored in the memory of a computer and/or server (e.g., data holding subsystem 204 of server 102 from FIGS. 1-2). As such, method 600 may be carried out by a logic system (e.g., logic subsystem 203 from FIGS. 1-2) of the computer and/or server.

Method 600 begins at 602 which comprise a consumer creating a consumer account. The consumer may input a username and/or password. Method 600 then continues to 604 and a consumer streams and/or downloads song from various artists. Thus the method at 600 may comprise a user streaming and/or downloading songs stored on the server. After a threshold amount of time (e.g., month, week, day), the consumer pays a subscription fee, where the subscription fee may be in the form of cryptocurrency. Said another way, a consumer may pay a subscription fee for the right to listen to songs for a subscription period, where the subscription period may be a duration. In the description herein, a consumer listening to songs may be used to refer to the consumer downloading and/or streaming songs. Thus, downloading and/or streaming songs may be simply referred to as listening hereinafter. As stated above the duration may be an amount of time (e.g., year, month, week, day, etc.). In some examples the subscription period may be a month. In such examples, a consumer may be a pre-set subscription fee each month. Thus, the subscription fee may be a constant pre-set fee that the consumer pays at regular time intervals. At the end of the subscription period, the consumer may pay the subscription fee again for the next subscription period.

The method 600 may then proceed to 608 which comprises determining the number of songs listened to (e.g., streamed and/or downloaded) by the consumer since the most recent subscription fee payment. Further, the method 600 may continue to 610 and determine the number of songs listened to by the consumer from each artist. The gross income of each artist may then be calculated at 612, by dividing the number of songs listened to by the consumer from each artist by the total number of songs listened to by the consumer, and then multiplying the resulting quotient by the subscription fee. Said another way, the gross income of each artist may be calculated by multiplying the subscription fee by the ratio of the number of songs listened to for a given artist to the total number of songs listened to in the given subscription period.

Subsequently at 614, a token burn amount and proportion of the gross income to be transferred to the artist may be estimated based on the deduction percentage in the manner described above with reference to 442 and 444 of FIG. 4A. The method may then continue to 616 which comprise destroying artist tokens from each artist based on the burn amount determined for each artist at 614. Method 600 may then return.

Various example displays which may be presented to artist and consumers regarding songs are shown below in FIGS. 7A-7H. Thus, FIGS. 7A-7H may show example interfaces displayed to a user on a display system (e.g., display subsystem 215 and 225 from FIG. 2), to allow a consumer and/or artist to stream and/or download songs.

Turning to FIG. 7A it shows a first display 700 which may be presented to an artist on an artist device (e.g., artist device 110 shown in FIGS. 1-4B) upon an artist request to create an artist account. Display 700 may include a name field 706 where an artist may input their name. Display 700 may further include an icon 708 where an artist may be required to upload legal documents verifying the identity of the artist. Thus, an artist may be required on display 700 to upload documents verifying their identity as the artist they are claiming to be when creating an account. Display 700 may also provide tabs for the artist to input their artist preferences. For example, as shown in display 700, the artist may input their desired number of artist tokens to be created on a token creation field 710, a deduction percentage (also referred to herein as a “buyback percentage”) on a deduction percentage field 714, and an initial token price on a token price field 712. As described above with reference to FIGS. 3-4B, the deduction percentage may be a percentage of income generated by the artist that the artist sets to be appropriated for buying and destroying artist tokens at their current selling price on a marketplace (e.g., online music marketplace 100 shown in FIGS. 1-4B). The token price may be an initial price that the artist wishes to sell their artist tokens for. After the inputs their preferences on display 700, their desired number of artist tokens may be generated and deposited in their artist wallet (e.g., artist wallet 111 shown in FIGS. 1-4B).

Further, a list of artists may be presented on an artist list tab 704 on the far left of the display 700. Additionally, a search tab 702 may be presented on the top of the display 700, where an artist may search for one or more songs, artists, albums, etc., via the search tab 702.

Turning to FIG. 7B it shows a second display 800 which may be presented to a consumer on a consumer device (e.g., artist device 110 shown in FIGS. 1-4B). A consumer may search for a specific song, artist, album, etc. at a search bar 802 positioned near the top of the display 800. An artist may save channels to their account. In some examples, the channels may be songs of particular artists, genres, albums, etc. In the example shown in FIG. 7B, a tab 804 including a list of channels may be presented on the left side of the display 800. The channels in the tab 804 are organized by artist such as U2, Eminem, Daft Punk, etc. The channels may be displayed in a tab positioned on the far left of the display 800.

Display 800 may additionally include several tabs which the consumer may select to sort, organize, and view artists, and/or their songs to either stream and/or download. Thus, a list of artists 806 comprising a plurality of artists 807 may be presented to the user on display 800. In the example shown in FIG. 7B, consumers may select a ‘trending’ tab 808, and view artists and/or their songs that are currently trending. Currently trending artists may be artists whose associated artist tokens (e.g., artist tokens 312 shown in FIGS. 3-4B) are increasing in value more quickly than other artists. In some examples, the trending artists may be artists whose artist token is increasing in value more quickly than other artists. Thus, in some examples all artists may be ranked according to how quickly their artist tokens are increasing in value. In the example shown in FIG. 7B, the rate of increase in the value of the artist tokens for Jay Z may be the highest of all artists since Jay Z is at the top of the trending artists. As described above with reference to FIGS. 4A-4B, the value of the artist tokens may be based on the current selling price of the artist token on the marketplace (e.g., online music marketplace 100 shown in FIGS. 1-4B).

Thus, a server, such as server 102 shown in FIG. 1, may monitor transactions on a block chain (e.g., block chain 103 shown in FIG. 1). During each transaction on the block chain, where an amount of cryptocurrency is transferred, from a consumer device (e.g., consumer device 120 shown in FIG. 1), to the artist device, a percentage of that cryptocurrency may be used to buy artist tokens and destroy them as described above with reference to FIG. 4-6. Additionally, the value/price of an artist token may fluctuate according to principles of supply and demand as the tokens are bought, sold, traded, etc., on an online marketplace (e.g., online music marketplace 100 shown in FIG. 1). Therefore, as explained above, the value/price of an artist token may increase for increases in the number of their songs streamed and/or downloaded, as a percentage of the income earned by the artist from each stream and/or download may be used to destroy their artist tokens. Thus, the value of the artist token may be monitored and used as a way for sorting and listing artists displayed to a user on the consumer device. In this way, a user may choose to sort artists may how quickly their artist token is increasing in value. Artist may be organized such that artists are listed in order with increasing rates of increase in the artist token value from bottom to top of the display 800.

Consumers may additionally sort artists by which artists are currently at the top. Thus, a ‘top’ tab 810 may be included in display 800 which upon selection may allow a consumer to view the top artists. The top artists may those artists whose artist tokens are at a higher value than the artist tokens of other artists. As such, the top artist may be the artist whose artist token has the highest current value. In such examples, the artist may be ranked according to the current value of their artist token.

In still further examples, consumers may select a ‘new’ tab 812 which may organize songs and/or artists by the most recent songs and/or artists that have been uploaded to the marketplace. Thus a consumer may sort which artists are shown on display 700 based on selections of the various tabs: ‘trending,’ top, ‘hot,’ and ‘new.’ Thus, upon selection of one of the tabs, a list of artists may be displayed to the consumer.

Further, a user may enter a search for a specific genre, or may select a specific channel. Then, a user may select one of the tabs, to sort the artists and/or songs presented on display 800 in response to their search and/or selection of a specific channel. In other examples, the consumer may select one of the tabs without inputting a search query or selecting a channel. As such, all songs and/or artists may be sorted by trending, top, hot, and new.

A consumer may then select a specific artist and/or song from the list of artists and/or songs displayed on the display 800. In response to the consumer selection of a specific artist and/or song, a third display, such as the display shown in FIG. 7C may be presented to a consumer.

Turning now to FIG. 7C, it shows an example display 900 that may be presented to a consumer in response to the consumer selection of a particular artist and/or song. Thus, in some examples display 900 may be presented to a consumer in response to the consumer selection of a particular artist displayed in display 800. Upon consumer selection of an artist, a window 902 may be presented to the consumer which allows the consumer to buy the artist tokens for the selected artist, select specific songs from that artist to download and/or stream, etc. In the example shown in FIG. 7C, upon consumer selection of a song, the window 902 may be presented to the consumer which allows the consumer to buy the artist tokens for the artist of the selected song, add the song to a playlist, flag the song, add a hashtag to the song, and/or share the song. If the consumer selects a ‘buy artist token’ tab 904, then a fourth display, such as the display shown in FIG. 7D may be presented to the consumer.

Turning now to FIG. 7D, it shows an example display 1000 that may be presented to a consumer, in response to a consumer selection for purchasing artist tokens for a particular artist. A display, such as display 900 shown in FIG. 7D, with a list of artists may be overlaid with a window 1002 presenting information to the consumer about a purchase of artist tokens. Thus, the window 1002 may be presented over display 900 in response to a consumer request to purchase artist tokens. A consumer may input an amount of cryptocurrency 1004 they wish to spend on the artist tokens, and a corresponding number of estimated artist tokens 1006 will be presented to the consumer. The estimated artist tokens may be a number of artist tokens that the consumer will receive in exchange for the amount of cryptocurrency they wish to spend, based on the current market value of the artist token. As explained above, the current market value of the artist tokens may be based on how much the tokens are currently being sold and/or bought for on the marketplace.

After confirming their purchase, a consumer may be presented with a fifth display, such as the display shown in FIG. 7E, which confirms the transaction. Thus, display 1100 shown in FIG. 7E may be presented to a consumer after the consumer performs a transaction to acquire artist tokens in exchange for a cryptocurrency such as bitUSD. The display 1100 may include window 1002 that confirms to the consumer, how much they spent on the artist token, and how many artist tokens they purchased. Thus, a confirmation 1104 may be included in the window 1002 confirming the transaction displayed previously in display 1000. Thus, display 1100 may be presented to a consumer and/or artist to show exchanges of cryptocurrency between the consumer and/or artist, and other consumer and/or artists in the marketplace. The cryptocurrency may be artist tokens, bitUSD, etc. In the example shown in FIG. 7F, cryptocurrency received from a consumer may be displayed to a consumer and/or artist on display 1200. Specifically, a list of transactions 1202 may include a plurality of transactions 1204. The status of the transactions 1204 (e.g., whether it has been completed or not), the date, amount, and type of cryptocurrency may all be displayed to the consumer and/or artist. Additionally, the artist and/or consumer may be presented with the identity of the source of the transaction. Thus, the artist and/or consumer can view from who they received cryptocurrency from.

In addition to viewing their recent transactions, a consumer and/or artist may also view their assets. An example display is shown in FIG. 7G which may be presented to a consumer and/or an artist, showing assets 1301 of that consumer and/or artist. The assets 1301 may be digital forms of currency which may include artist tokens, cryptocurrency, artist merchandise, etc. As such, in some examples, display 1300 may be a visual representation of a consumer wallet (e.g., consumer wallet 121 shown in FIGS. 1-4B) and/or an artist wallet (e.g., artist wallet 111 shown in FIGS. 1-4B).

The artist wallet may present information about all of the assets 1301 currently owned by the artist and/or consumer. Specifically, the asset information may include an artist token ID 1302, which identifies each artist token as being the artist token of a particular artist (e.g. Jay Z′ artist token, ‘Beyoncë’ artist token, etc.), a share 1304 which identifies the number of each artist token owned by the consumer and/or artist, and a corresponding worth 1306 of those artist tokens in bitUSD or other cryptocurrency. It is important to note that each artist may be assigned a unique artist token ID. In some examples, as shown in FIG. 7G the artist token ID may be four letters long. However, in other examples the artist token ID may be more or less than four letters long. In the example shown in display 1300 the consumer and/or artist may have 758 artist tokens from an artist, where the artist ID is ‘BTSX.’ The artist tokens may be worth an estimated $400 in bit USD. Additionally, a consumer and/or artist may select a specific asset, and be presented with additional information about that asset, such as the total number of artist tokens in the marketplace (e.g., online music marketplace 100 shown in FIGS. 1-4B). Further, the currency value of the artist token, and the name of the artist to which the artist token is assigned may also be shown. In addition to the current value of a particular artist token, a consumer and/or artist may be presented with a graph, such as the graph shown in FIG. 7H, displaying fluctuations in the value of a particular artist token over time.

Moving to FIG. 7H, is shows an example display 1400 that may be displayed to a consumer and/or artist showing a graph 1404 depicting example fluctuations in the value of an artist token. The graph 1404 may be presented on tab 1402 of the display 1400. In the example shown in FIG. 7H, fluctuations in the value of the artist token ‘BTS’ are shown on the graph 1404. A consumer and/or artist may select to display fluctuations of the artist token over different time intervals (e.g., 5 minutes, 15 minutes, 30 minutes, hourly, etc.) In the example shown in FIG. 7H, fluctuations in ‘BTS’ are shown for the last three hours. Thus, the price that the artist token has been selling for on the market may be plotted against time in the display 1400. A consumer and/or artist may therefore view the price at which the artist tokens of a particular artist are being bought and/or sold for on the marketplace.

Thus, transaction information stored on a block chain (e.g., block chain 103 shown in FIGS. 1-3) may be recorded and organized by the artist token ID of each different artist token. Thus, all transactions recorded on the block chain may be sorted by the artist to whom the artist tokens were originally assigned. In the example, of FIG. 7H, all transactions involving ‘BTS’ artist tokens within the most recent three hours are shown. Thus, a method may be included for recording, and analyzing all transactions involving artist tokens with a particular artist ID. Further, the method may include generating a graph for those transactions and displaying the value of the artist tokens with the particular artist ID based on the price that the tokens were bought and/or sold for on the open market (e.g. online music marketplace 100 shown in FIGS. 1-4B).

Put more simply, a method may comprise recording a plurality of digital transactions involving the artist tokens for a particular artist, and generating a transaction history for the artist tokens of that artist. The transaction history may include information relating to the monetary value of each artist token for each of the plurality of digital transactions. Additionally, the method may include generating a graph showing the transaction history of the artist tokens, and displaying the graph to a consumer on the consumer device.

In one representation, a method may comprise in response to a request from an artist via an artist device, generating a desired number of artist tokens, transmitting the artist tokens to a first digital wallet of the artist device via a network, performing a digital transaction between a consumer device and the artist device, where the digital transaction includes transferring an amount of cryptocurrency from a second digital wallet of the consumer device to the first digital wallet of the artist device, in exchange for one or more of artist tokens, artist produced songs, and artist merchandise, destroying a portion of the artist tokens based on one or more of the amount of cryptocurrency transferred from the second digital wallet, and a deduction percentage, recording the digital transaction on a block chain, and displaying the digital transaction to a consumer device. In some examples, the artist tokens may be a type of cryptocurrency comprising both private and public keys. In any one or more combinations of the above methods, the artist merchandise includes digital tickets, promotional offers, and VIP passes. In any one or more combinations of the above methods the artist produced songs are one or more of performed, produced and composed by the artist. Any one or more combinations of the above methods may further comprise storing artist produced songs received from a plurality of artist devices in non-transitory memory on a server in wireless communication with the consumer device and artist device via a network.

Any one or more combinations of the above methods may further comprise receiving a subscription fee from the consumer device in a form of cryptocurrency after the expiration of a subscription period. Any one or more combinations of the above methods may further comprise calculating a portion of the subscription fee to be transmitted to the first digital wallet of the artist device based on a proportion of a number of songs transmitted to the consumer device during the subscription period belonging to the artist, and where the portion of the subscription fee increases for increases in the proportion of the number of songs transmitted to the consumer device during the subscription period that belong to the artist. In any one or more combinations of the above methods, the deduction percentage is based on artist input received via the artist device prior to the generating of the artist tokens. Any one or more combinations of the above methods may further comprise, recording the digital transaction on a block chain. In any one or more combinations of the above methods, the deduction percentage is a percentage of the cryptocurrency transferred from the second digital wallet. In any one or more combinations of the above methods, the destroying of the artist tokens may further comprise purchasing artist tokens with the deduction percentage of the cryptocurrency transferred from the second digital wallet based on a value of the artist tokens. Any one or more combinations of the above methods may further comprise, assigning a rank to the artist tokens based on a rate of increase in a value of the artist tokens. Any one or more combinations of the above methods may further comprise, generating a graph depicting changes in the value of the artist tokens, and displaying the graph on the consumer device.

In another representation, a method may comprise receiving a subscription fee from a consumer device, transmitting one or more songs from a music database to a user device based on song requests received from the user device during a subscription period, splitting the subscription fee amongst one or more artist wallets of one or more artists based on a proportion of the one or more songs transmitted to the user device that belong to each of the one or more artists, destroying artist tokens for each of the one or more artists based on the splitting of the subscription fee, adjusting values of artist tokens for each of the one or more artists based on a number of destroyed artist tokens for each of the one or more artists, monitoring values of the artist tokens over a duration, and displaying a graph to the user device depicting changes in the values of the artist tokens over the duration. In any one or more combinations of the above methods the number of destroyed artist tokens for an artist increases for increases in the proportion of the one or more songs transmitted to the user device that belong to the artist. In any one or more combinations of the above methods a value of the artist tokens for the artist increases for increases in the number of destroyed artists tokens for the artist. In any one or more combinations of the above methods the destroying the artist tokens comprising may comprise deleting public and private keys associated with the artist tokens. Any one or more combinations of the above methods may further comprise determining a popularity for each of the one or more artists based on the values of the tokens for each of the one or more artists.

In yet a further representation, a system may comprise a consumer device for streaming and downloading music, an artist device for uploading music, and a remote server in wireless communication with the consumer device and artist device for receiving and storing music uploaded from the artist device and delivering the music to the consumer device, the remote server comprising computer readable instruction stored in non-transitory memory for: transferring artist tokens from the artist device to the consumer device in exchange for cryptocurrency from the consumer device, and transferring cryptocurrency from the consumer device to the artist device based on a number of songs streamed and/or downloaded by the consumer device and belonging to an artist of the artist device. The system may further comprise a block chain including a record of transactions between the artist device and consumer device.

Thus, a technical effect of creating a peer-to-peer network through which music may be transferred in exchange for currency directly between an artist and a consumer is achieved. Further, a technical effect of creating an artist marketplace is achieved via a block chain including artist tokens, where the values of the artist tokens fluctuate based on the relative popularity of an artist amongst each consumer. Thus, a network of devices comprising a block chain may be created that together regulates the value of the artist tokens. Further, a music marketplace may be created that promotes an artist outside of their music sales. As such, a technical effect of combining a peer-to-peer network that comprises an artist token stock market, with a subscription fee splitting server that delivers music streaming and downloading to consumers is achieved.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property. The terms “including” and “in which” are used as the plain-language equivalents of the respective terms “comprising” and “wherein.” Moreover, the terms “first,” “second,” and “third,” etc. are used merely as labels, and are not intended to impose numerical requirements or a particular positional order on their objects.

This written description uses examples to disclose the invention, including the best mode, and also to enable a person of ordinary skill in the relevant art to practice the invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

1. A method, comprising:
in response to a request from an artist via an artist device, generating a desired number of artist tokens;
transmitting the artist tokens to a first digital wallet of the artist device via a network;
performing a digital transaction between a consumer device and the artist device, where the digital transaction includes transferring an amount of cryptocurrency from a second digital wallet of the consumer device to the first digital wallet of the artist device, in exchange for one or more of artist tokens, artist produced songs, and artist merchandise;
destroying a portion of the artist tokens based on one or more of the amount of cryptocurrency transferred from the second digital wallet, and a deduction percentage;
recording the digital transaction on a block chain; and
displaying the digital transaction to a consumer device.

2. The method of claim 1 wherein the artist tokens are a type of cryptocurrency comprising both private and public keys.

3. The method of claim 1, where the artist merchandise includes digital tickets, promotional offers, and VIP passes.

4. The method of claim 1, where the artist produced songs are one or more of performed, produced and composed by the artist.

5. The method of claim 1, further comprising storing artist produced songs received from a plurality of artist devices in non-transitory memory on a server in wireless communication with the consumer device and artist device via a network.

6. The method of claim 1 further comprising, receiving a subscription fee from the consumer device in a form of cryptocurrency after the expiration of a subscription period.

7. The method of claim 6 further comprising, calculating a portion of the subscription fee to be transmitted to the first digital wallet of the artist device based on a proportion of a number of songs transmitted to the consumer device during the subscription period belonging to the artist, and where the portion of the subscription fee increases for increases in the proportion of the number of songs transmitted to the consumer device during the subscription period that belong to the artist.

8. The method of claim 1, where the deduction percentage is based on artist input received via the artist device prior to the generating of the artist tokens.

9. The method of claim 1 further comprising, recording the digital transaction on a block chain.

10. The method of claim 1, where the deduction percentage is a percentage of the cryptocurrency transferred from the second digital wallet.

11. The method of claim 1, where the destroying of the artist tokens further comprises purchasing artist tokens with the deduction percentage of the cryptocurrency transferred from the second digital wallet based on a value of the artist tokens.

12. The method of claim 1 further comprising, assigning a rank to the artist tokens based on a rate of increase in a value of the artist tokens.

13. The method of claim 12 further comprising, generating a graph depicting changes in the value of the artist tokens, and displaying the graph on the consumer device.

14. A method comprising:
receiving a subscription fee from a consumer device;
transmitting one or more songs from a music database to a user device based on song requests received from the user device during a subscription period;
splitting the subscription fee amongst one or more artist wallets of one or more artists based on a proportion of the one or more songs transmitted to the user device that belong to each of the one or more artists;
destroying artist tokens for each of the one or more artists based on the splitting of the subscription fee;
adjusting values of artist tokens for each of the one or more artists based on a number of destroyed artist tokens for each of the one or more artists;
monitoring values of the artist tokens over a duration; and
displaying a graph to the user device depicting changes in the values of the artist tokens over the duration.

15. The method of claim 14, wherein the number of destroyed artist tokens for an artist increases for increases in the proportion of the one or more songs transmitted to the user device that belong to the artist.

16. The method of claim 15, wherein a value of the artist tokens for the artist increases for increases in the number of destroyed artists tokens for the artist.

17. The method of claim 14, wherein the destroying the artist tokens comprising may comprise deleting public and private keys associated with the artist tokens.

18. The method of claim 14 further comprising, determining a popularity for each of the one or more artists based on the values of the tokens for each of the one or more artists.

19. A system comprising:
a consumer device for streaming and downloading music;
an artist device for uploading music; and
a remote server in wireless communication with the consumer device and artist device for receiving and storing music uploaded from the artist device and delivering the music to the consumer device, the remote server comprising computer readable instruction stored in non-transitory memory for:
transferring artist tokens from the artist device to the consumer device in exchange for cryptocurrency from the consumer device; and
transferring cryptocurrency from the consumer device to the artist device based on a number of songs streamed and/or downloaded by the consumer device and belonging to an artist of the artist device.

20. The system of claim 19, further comprising a block chain including a record of transactions between the artist device and consumer device.
